(19) United States
(12) Patent Application Publication
(10) Pub. No.: US 2009/0014250 A1
(43) Pub. Date: Jan. 15, 2009

(54) ELEVATOR

(76) Inventor: Soon Gil Jang, Seoul (KR)

Correspondence Address: IPLA P.A., 3580 WILSHIRE BLVD., 17TH FLOOR, LOS ANGELES, CA, 90010, US

(21) Appl. No.: 11/576,784

(22) PCT Filed: Nov. 22, 2005
(86) PCT No.: PCT/KR05/03958

§ 371 Date: Apr. 5, 2007

(30) Foreign Application Priority Data
Nov. 25, 2004 (KR) 10-2004-0097733
Aug. 3, 2005 (KR) 10-2005-0070849

(51) Int. Cl. B66B 11/06; B66B 11/04; B66B 1/34

(52) U.S. Cl. 187/257; 187/289; 187/404; 187/285

(57) ABSTRACT

Disclosed herein is an elevator which has an improved structure such that a balance weight offsets the weight of a cage, passengers, and cargo to the utmost, according to changes in weight of the passengers and cargo, thus reducing power consumption. In the elevator of the present invention, a gear ratio of a transmission (21) is adjusted in consideration of the number of passengers or the weight of cargo, so that power consumption required for operating the elevator is reduced. Furthermore, in the case of use of an electronic variable capacity hydraulic motor (291), the elevator is controlled depending on changes in weight of passengers and cargo, such that a balance weight (12) offsets the weight of a cage, the passengers and cargo to the utmost, thus reducing power consumption required for operating the elevator.

### TECHNICAL FIELD

The present invention relates, in general, to elevators which are mechanical devices for vertically carrying passengers or cargo and, more particularly, to an elevator which has an improved structure such that a balance weight offsets the weight of a cage, passengers and cargo to the utmost, according to changes in weight of the passengers and cargo, thus reducing power consumption of the elevator.

### BACKGROUND ART

Generally, as shown in FIG. 1, an elevator includes a cage 1, which is loaded with cargo or passengers, a balance weight 2, which is coupled to the cage 1 through a wire rope 4, and a pulley 3, around which the wire rope 4 is wrapped. The pulley 3 is coupled to an electromotor, so that it is rotated in a direction using power of the electromotor, thus lifting the cage 1. When the elevator is installed, the balance weight 2 is set such that it has a predetermined weight N.

In the conventional elevator having the above-mentioned construction, the sum of the weight M of the cage and a weight P of passengers and cargo is not constants that is, it is variable according to circumstances. As such, because the sum of the weight M of the cage 1 and a weight P of passengers and cargo is variable, when the cage 1 is operated by the electromotor, the electromotor consumes a large amount of power to respond to variable weight.

Therefore, to reduce power consumption of the elevator, the conventional elevator has a structure in which the balance weight 2 is coupled to the cage 1 using the pulley 3. However, the balance weight 2 cannot perfectly offset the weight of the cage 1, because the weight of the passengers and cargo is variable. Accordingly, an elevator in which a balance weight can offset the weight of a cage as much as possible depending on a change in weight of passengers and cargo so as to reduce power consumption has been required.

### DISCLOSURE OF INVENTION

### Technical Problem

Accordingly, the present invention has been made keeping in mind the above problems occurring in the prior art, and an object of the present inventions is to provide an elevator which has an improved structure such that a balance weight offsets the weight of a cage, passengers and cargo to the utmost, according to changes in weight of the passengers and cargo, thus reducing power consumption.

### Technical Solution

In an aspect, the present invention provides an elevator operated between a lowermost floor and an uppermost floor of a building to carry passengers and cargo, the elevator including: an electromotor; a cage provided in the building so as to be raised for carrying the passengers and cargo; a cage winch rotated by the electromotor, so that a wire rope coupled to the cage is wound around or unwound from the cage winch: a balance weight providing a predetermined load to balance a weight of the cage and a weight of the passengers and cargo to be carried by the cage; a balance weight winch rotated using power transmitted from the cage winch to raise the balance weight; an electronic control transmission provided between the balance weight winch and the cage winch to selectively transmit power therebetween, the electronic control transmission being set into a predetermined gear ratio depending on an input signal and transmitting power between the winches; and a control unit to control the electronic control transmission in consideration of the weight of the cage, the passengers and the cargo, a weight of the balance weight, and positions of the cage and balance weight, so that the electronic control transmission is set into a gear ratio such that the weight of the cage side is balanced with the weight of the balance weight.

The elevator may further include a wire rope coupled to each of the cage and the balance weight such that an end of the wire rope is in contact with a bottom of the lowermost floor of the building.

The cage winch may be provided on a drive shaft which is coupled between the electronic control transmission and the electromotor, and the balance weight winch may be provided on a driven shaft, which is coupled to the electronic control transmission so that power is transmitted from the drive shaft to the driven shaft.

The balance weight may comprise a plurality of balance weights, and the balance weight winch may comprise a plurality of balance weight winches. The elevator may further include a driven shaft coupled to the balance weight winches and receiving power from a drive shaft through the electronic control transmission; and a plurality of electronic control clutches, each of the electronic control clutches provided between the driven shaft and each of the balance weight winches and selectively operated by the control unit to transmit power therebetween.

The electronic control transmission includes: a brake provided on the drive shaft; a plurality of sliding gears having different radii and slidably provided on the drive shaft; and a plurality of stationary gears provided on the driven shaft at predetermined positions and selectively geared with the plurality of sliding gears.

Each of the electronic control clutches may include: a stationary gear provided on the driven shaft; a brake provided on a shaft of the balance weight winch; and a sliding gear provided on the shaft of the balance weight winch and selectively engaging with the stationary gear.

The electronic control transmission may include: a first brake provided on the drive shaft; a second brake provided on the driven shaft; a plurality of sliding gears having different radii and movably provided on the drive shaft; and a plurality of stationary gears provided on the driven shaft and selectively geared with the plurality of sliding gears.

The electronic control transmission may comprise a continuously variable transmission.

In another aspect, the present invention provides an elevator operated between a lowermost floor and an uppermost floor of a building to carry passengers and cargo, the elevator including: an electromotor; a cage provided in the building so as to be raised for carrying the passengers and cargo; a first winch rotated by the electromotor, so that a wire rope coupled to the cage is wound around or unwound front the first winch; a balance maintenance member providing a predetermined load to balance a weight of the cage and a weight of the passengers and cargo to be carried by the cage; a second winch rotated using power transmitted from the first winch to lift the balance weight; an electronic control transmission provided between the first and second winches to selectively transmit power therebetween, the electronic control transmission being set into a predetermined gear ratio depending on an input signal and transmitting power from the first winch to the second winch; and a control unit to control the electronic control transmission in consideration of the weight of the cage. The passengers and the cargo, the load of the balance maintenance member, and a position of the cage, so that the electronic control transmission is set into a gear ratio such that the weight of the cadge side is balanced with the load of the balance maintenance member.

The balance maintenance member may include a chain structure weight, having a predetermined length and a predetermined weight, placed at a first end thereof on a bottom of the building and placed at a second end thereof at an upper position of the building, the chain structure weight wrapped around the second winch, so that, when the second winch is rotated in a direction, the chain structure weight passes over the second winch and is moved towards one end, which is placed on the bottom or at the upper position, and a remaining end thereof is pulled out.

The chain structure weight may include: a plurality of bars each having a predetermined length and weight; and a chain roller having a predetermined length and rotatably supporting each of opposite ends of the bars.

The second winch may include a sprocket wheel unit to move the chain rollers.

The elevator may further include a wire rope coupled to a lower end of the cage such that an end thereof contacts the bottom of the building.

The first winch may be provided on a drive shaft which is coupled between the electromotor and the electronic control transmission, and the second winch may be provided on a driven shaft which is coupled to the electronic control transmission so that power is transmitted from the drive shaft to the driven shaft.

In a further aspect, the present invention provides an elevator operated between a lowermost floor and an uppermost floor of a building to carry passengers and cargo, the elevator including: an electromotor; a cage provided in the building so as to be raised for carrying the passengers and cargo; a cage winch rotated by the electromotor, so that a wire rope coupled to the cage is wound around or unwound from the first winch; a balance maintenance means for providing a predetermined load to balance a weight of the cage and a weight of the passengers and cargo to be carried by the cage; an electronic control transmission provided between the cage winch and the balance maintenance means to selectively transmit power therebetween, the electronic control transmission being set into a predetermined gear ratio depending on an input signal and transmitting power from the cage winch to the balance maintenance means; and a control unit to control the electronic control transmission in consideration of the weight of the cage, the weight of the passengers and cargo, the load of the balance maintenance means, and a position of the cage, so that the electronic control transmission is set into a gear ratio such that the weight of the cage side is balanced with the load of the balance maintenance means.

The balance maintenance means may include: upper and lower liquid tanks each containing liquid therein; and a liquid carrying unit operated in conjunction with a driven shaft, which receives power from a drive shaft of the cage winch through the electronic control transmission, the liquid carrying unit moving liquid from either the upper or lower liquid tank to the remaining one, thus varying potential energy.

The liquid carrying unit may include: a pipe connecting the upper liquid tank to the lower liquid tank; at least one hydraulic motor provided on the pipe; and a rotating shaft coupled at an end thereof to the drive shaft, so that, when the rotating shaft is rotated, the hydraulic motor is operated.

The rotating shaft and the driven shaft may be coupled to each other using bevel gears.

The hydraulic motor may comprise a plurality of hydraulic motors, and the plurality of hydraulic motors may be connected to each other by at least one method of serial and parallel connection methods.

The rotating shaft may be disposed such that the plurality of hydraulic motors shale the rotating shaft.

The elevator may further include a wire rope coupled to a lower end of the cage such that an end thereof contacts the bottom of the building.

The liquid carrying unit may include: a closed-loop-type carrying chain provided via the upper and lower liquid tanks, the carrying chain being movable in opposite directions; a plurality of buckets provided on the carrying chain at regular intervals, so that, when the carrying chain moves in a direction, the buckets carry liquid from either the upper or lower liquid tank to the remaining one according to the direction in which the carrying chain moves; and a sprocket wheel unit provided on the drive shaft to move the carrying chain.

Each of the buckets may include a pair of protruding rods thereon, and each of the upper and lower liquid tanks may include a stop plate therein, so that, when the protruding rods of the buckets are caught by the stop plate, liquid is spilled from the bucket into the upper or lower liquid tank.

The balance maintenance means may include: an airtight liquefied gas tank storing liquefied gas therein; an airtight high-pressure liquid tank connected to the liquefied gas tank and containing therein liquid and liquefied gas allowed to flow into the liquefied gas tank; an atmospheric pressure liquid tank connected to the high-pressure liquid tank through a pipe and containing therein liquid at an atmospheric pressure; a hydraulic motor provided on the pipe, so that liquid is carried from either the high-pressure liquid tank or the atmospheric pressure liquid tank into the remaining one according to a rotating direction of the hydraulic motor; and a rotating shaft operated by the driven shaft, which receives power from the drive shaft of the cage winch through the electronic control transmission, thus operating the hydraulic motor.

In yet another aspect, the present invention provides an elevator operated between a lowermost floor and an uppermost floor of a building to carry passengers and cargo, the elevator including: an electromotor; a cage provided in the building so as to be raised for carrying the passengers and cargo; a balance weight having a predetermined weight corresponding to the cage and moved in a direction opposite the cage to balance therebetween; a closed-loop-type wire rope coupling the cage and the balance weight to each other; a cage winch rotated by the electromotor and moving the wire rope; a balance pulley provided at a position corresponding to the cage winch to support the movement of the wire rope; an electronic control transmission provided between a shaft of the balance pulley and a driven shaft, which selectively receives power from the shaft of the balance pulley; a control unit to control the electronic control transmission; and a balance maintenance means operated by the driven shaft and for providing a load to the drive shaft, thus offsetting a weight of the passengers and cargo carried by the cage.

The balance maintenance means may include: an airtight liquefied gas tank storing liquefied gas therein; an airtight high-pressure liquid tank connected to the liquefied gas tank and containing therein liquid and liquefied gas allowed to flow into the liquefied gas tank; an atmospheric pressure liquid tank connected to the high-pressure liquid tank through a pipe and containing therein liquid at an atmospheric pressure; and a hydraulic motor provided on the pipe and moving liquid from either the high-pressure liquid tank or the atmospheric pressure liquid tank into the remaining one according to a rotating direction thereof, and the driven shaft may be a rotating shaft of the hydraulic motor.

In still another aspect, the present invention provides an elevator operated between a lowermost floor and an uppermost floor of a building to carry passengers and cargo, the elevator including: an electromotor; a cage provided in the building so as to be raised for carrying the passengers and cargo; a cage winch rotated by the electromotor, so that a wire rope coupled to the cage is wound around or unwound from the first winch; a balance maintenance means for providing a predetermined load to balance against a weight of the cage and a weight of the passengers and cargo to be carried by the cage; a brake provided between the cage winch and the balance maintenance means to selectively interrupt power transmission therebetween; and a control unit to control both the brake and the balance maintenance means in consideration of the weight of the cage, the weight of the passengers and cargo, the load of the balance maintenance means, and a position of the cage, such that the weight of the cage side is balanced with the load of the balance maintenance means. The balance maintenance means includes: upper and lower liquid tanks each containing liquid therein; a pipe connecting the upper liquid tank to the lower liquid tank; and an electronic variable capacity hydraulic motor provided on the pipe and controlled by the control unit such that an output torque and a rotating speed thereof are controlled by adjusting a displacement volume per one revolution of an output shaft of the hydraulic motor which is coupled to a shaft of the brake.

The output shaft of the electronic variable capacity hydraulic motor and the shaft of the brake may be coupled to each other using bevel gears.

The elevator may further include a wire rope coupled to a lower end of the cage such that an end thereof contacts the bottom of the building.

In still another aspect, the present invention provides an elevator operated between a lowermost floor and an uppermost floor of a building to carry passengers and cargo, the elevator including: an electromotor; a cage provided in the building so as to be raised for carrying the passengers and cargo; a balance weight having a predetermined weight corresponding to the cage and moved in a direction opposite the cage to balance therebetween; a closed-loop-type wire rope coupling the cage and the balance weight to each other; a cage winch rotated by the electromotor and moving the wire rope; a balance pulley provided at a position corresponding to the cage winch to support the movement of the wire rope; an electronic control brake having a brake shaft and coupled to a shaft of the balance pulley, so that the electronic control brake is operated using power selectively transmitted from the shaft of the balance pulley; balance maintenance means operated by the brake shaft and for providing a load to the shaft of the balance pulley, thus offsetting a weight of both the passengers and cargo carried by the cage; and a control unit to control operation of the balance maintenance means and the electronic control brake.

The balance maintenance means may include: an airtight liquefied gas tank storing liquefied gas therein; an airtight high-pressure liquid tank connected to the liquefied gas tank and containing therein liquid and liquefied gas allowed to flow into the liquefied gas tank; an atmospheric pressure liquid tank connected to the high-pressure liquid tank through a pipe and containing therein liquid at an atmospheric pressure; and an electronic variable capacity hydraulic motor provided on the pipe, so that liquid is carried from either the high-pressure liquid tank or the atmospheric pressure liquid tank into the remaining one according to a rotating direction of the hydraulic motor, the hydraulic motor being controlled by the control unit such that an output torque and a rotating speed thereof are controlled by adjusting a displacement volume per one revolution of an output shaft of the hydraulic motor, and the shaft of the brake may be coupled to the output shaft of the electronic variable capacity hydraulic motor.

The shaft of the brake may be integrated with the output shaft.

In still another aspect, the present invention provides an elevator operated between a lowermost floor and an uppermost floor of a building to carry passengers and cargo, the elevator including: an electromotor; a cage provided in the building so as to be raised for carrying the passengers and cargo; a balance weight having a predetermined weight corresponding to the cage and moved in a direction opposite the cage to balance therebetween; a closed-loop-type wire rope coupling the cage and the balance weight to each other; a cage winch rotated by the electromotor and moving the wire rope, a balance pulley provided at a position corresponding to the cage winch to support the movement of the wire rope; an electronic control brake having a brake shaft and coupled to a shaft of the cage winch so that the electronic control brake is operated using power selectively transmitted from the shaft of the cage winch; a balance maintenance means operated by the brake shaft and for providing a load to the shaft of the balance pulley, thus offsetting a weight of both the passengers and cargo carried by the cage; and a control unit to control operation of the balance maintenance means and the electronic control brake.

The balance maintenance means may include: an airtight liquefied gas tank storing liquefied gas therein; an airtight high-pressure liquid tank connected to the liquefied gas tank and containing therein liquid and liquefied gas allowed to flow into the liquefied gas tank; an atmospheric pressure liquid tank connected to the high-pressure liquid tank through a pipe and containing therein liquid at an atmospheric pressure; and an electronic variable capacity hydraulic motor provided on the pipe, so that liquid is carried from either the high-pressure liquid tank or the atmospheric pressure liquid tank into the remaining one according to a rotating direction of the hydraulic motor, the hydraulic motor being controlled by the control unit such that an output torque and a rotating speed thereof are controlled by adjusting a displacement volume per one revolution of an output shaft of the hydraulic motor, and the shaft of the brake may be coupled to the output shaft of the electronic variable capacity hydraulic motor.

The shaft of the brake and the output shaft may be coupled to each other using bevel gears.

The balance maintenance means may include: upper and lower liquid tanks each containing liquid therein; a pipe connecting the upper liquid tank to the lower liquid tank; and an electronic variable capacity hydraulic motor provided oil the pipe and controlled by the control unit such that an output torque and a rotating speed thereof are controlled by adjusting a displacement volume per one revolution of an output shaft of the hydraulic motor which is coupled to the shaft of the brake.

The output shaft of the electronic variable capacity hydraulic motor and the shaft of the brake may be coupled to each other using bevel gears.

### ADVANTAGEOUS EFFECTS

In an elevator of the present invention, a gear ratio of a transmission is adjusted in consideration of the number of passengers or the weight of cargo, so that there is an advantage in that power consumption required for operating the elevator is reduced.

In the case of use of an electronic variable capacity hydraulic motor, the present invention is controlled depending on the change in weight of passengers and cargo, such that a balance weight offsets the weight of a cage, the passengers and cargo to the utmost, thus reducing power consumption required for operating the elevator.

### BRIEF DESCRIPTION OF THE DRAWINGS

FIG. 1 is a schematic view illustrating a conventional elevator;

FIG. 2 is a schematic view illustrating an elevator according to a first embodiment of the present invention;

FIG. 3 is a schematic view illustrating an elevator according to a second embodiment of the present invention;

FIG. 4 is a view showing a critical part of the elevator of FIG. 3;

FIG. 5 is a schematic view illustrating the elevator according to the second embodiment of the present invention;

FIG. 6 is a schematic view illustrating an elevator according to a third embodiment of the present invention;

FIG. 7 is a schematic view illustrating an elevator according to a fourth embodiment of the present invention;

FIG. 8 is a view illustrating an example of a chain structure weight of the elevator of FIG. 7;

FIGS. 9 and 10 are views illustrating another example of the chain structure weight of the elevator of FIG. 7;

FIG. 11 is a perspective view showing a sprocket wheel shown in FIG. 7;

FIG. 12 is a view showing a gear pump according to the present invention;

FIG. 13 is a view showing a vane pump according to the present invention;

FIG. 14 is a schematic view illustrating an elevator according to a fifth embodiment of the present invention;

FIG. 15 is a schematic view illustrating an elevator according to a sixth embodiment of the present invention;

FIG. 16 is a schematic view illustrating an elevator according to a seventh embodiment of the present invention;

FIG. 17 is a perspective view showing a bucket of the elevator of FIG. 16;

FIG. 18 is a perspective view showing the bucket of FIG. 17 which is in a state of being supported by a roller chain;

FIG. 19 is a schematic view illustrating an elevator according to an eight embodiment of the present invention;

FIG. 20 is a schematic view illustrating an elevator according to a ninth embodiment of the present invention;

FIG. 21 is a schematic view illustrating an elevator according to a tenth embodiment of the present invention;

FIG. 22 is a schematic view illustrating an elevator according to an eleventh embodiment of the present invention;

FIG. 23 is a schematic view illustrating an elevator according to a twelfth embodiment of the present invention; and

FIG. 24 is a schematic view illustrating an elevator according to a thirteenth embodiment of the present invention.

### DESCRIPTION OF THE ELEMENTS IN THE DRAWING

1,11,31 . . . cage 2,12,35,89,99 . . . balance weight
4,13,14,47,49 . . . wire rope 5,23 . . . cage winch
6,25,88,98 . . . balance weight winch 21,21′,225 . . . electronic control transmission
27 . . . electromotor 29,30 . . . control unit
*81,91 . . . electronic control clutch 203,204,205,206,279 . . . hydraulic motor
210,253 . . . upper liquid tank 212,255 . . . lower liquid tank
223 . . . winch 227 . . . balance pulley
284 . . . vinyl film 291 . . . electronic variable capacity hydraulic motor
293 . . . brake

### BEST MODE FOR CARRYING OUT THE INVENTION

Hereinafter, elevators according to embodiments of the present invention will be described in detail with reference to the attached drawings.

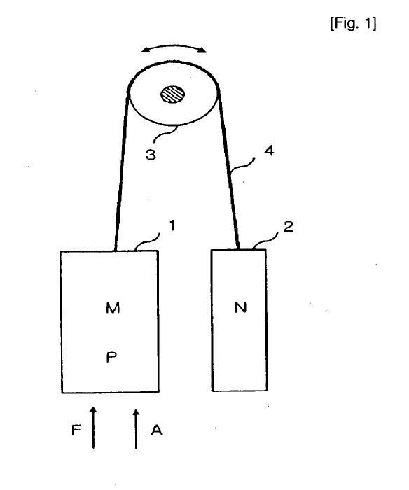

First, the conventional elevator shown in FIG. 1 will be analyzed more concretely to find out problems of the conventional elevator in further detail.

When a cage 1 is coupled to a balance weight 2 using a pulley 3, as shown in FIG. 1, an equation for force and acceleration applied to the cage 1 is explained as follows:

(M+P+N)×A=−(M+P−N)×G, thus

A=−(M+P−N)/(M+P+N)×G.

As indicated by the above-mentioned equation, when the sum of P and M is equal to N, A (the acceleration of the cage 1) is 0. However, if P is increased so that the sum of P and M is greater than N, A has a negative value. At this time, the cage 1 falls towards the ground at a certain rate of acceleration. Here. G is the gravitational acceleration.

Furthermore, when the force F is added to the above equation, the force and the acceleration applied to the cage 1 are expressed by the following equation.

(M+P+N)×A=F−(M+P−N)×G, so that

F=(M+P+N)×A+(M+P−N)×G

Of the components of the force F, the component (M+P+N)×A is generated by acceleration or deceleration, and the component (M+P−N)×G is generated by gravity, regardless of acceleration or deceleration. The component (M+P−N)×G is a force which is applied even in a stationary state or in uniform motion. From the above-mentioned equations, it is appreciated that the force F must be increased in proportion to the increase of M, N, P and A. Furthermore, it is appreciated that, when a value of (M+P−N) is 0, the component (M+P−N)×G related to G becomes zero. As well, it is appreciated that, if M and N are constant and P is variable, reducing the value of (M+P−N)×G is limited.

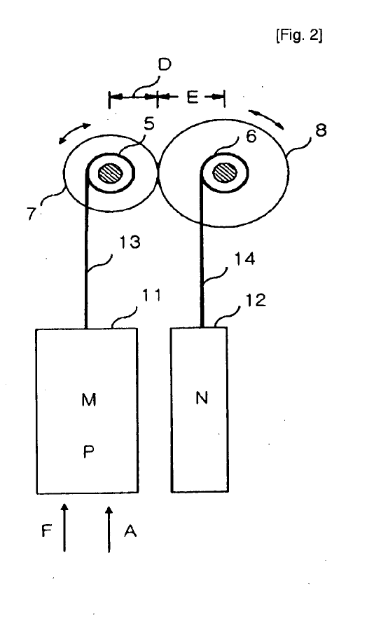

FIG. 2 is a schematic view illustrating an elevator according to a first embodiment of the present invention. Referring to 2, the elevator according to the first embodiment includes a cage 11 and a first winch 5 which is connected to the cage 11 through a wire rope 13 wound around the first winch 5. The elevator further includes a balance weight 12, a second winch 6 connected to the balance weight 12 through a wire rope 14 wound around the second winch 6, and two gears, a drive gear 7 and a driven gear 8, which engage with each other and are respectively provided on shafts of the first and second winches 5 and 6. The shaft of the first winch 5 is rotated using the power of an electromotor, which is connected to the shaft but not shown in the drawings.

For ease of calculation, the following explanation assumes that the diameter of wheels of the first and second winches 5 and 6 are equal to each other. Here, a gear ratio of the first gear 8, which is connected to the shaft of the winch 6 related to the balance weight, to the first gear 7, which is connected to the shaft of the winch 5 connected to the cage 11, is designated by K. In FIG. 2, the gear ratio K is expressed by K=E/D. At this time, an equation for a force and an acceleration applied to the cage 11 is explained as follows:

(M+P+N/K)×A=−(M+P−N/K)×G, thus

A=−(M+P−N/K)/(M+P+N/K)×G.

From this equation, it is understood that, as the second gear 8 related to the balance weight 12 is large, that is, as K is increased, an effect of the weight N is reduced.

Furthermore, when the force F is added to the above equation, the force and the acceleration applied to the cage 11 are expressed by the following equation.

(M+P+N/K)×A=F−(M+P−N/K)×G, so that

F=(M+P+N/K)×A+(M+P−N/K)×G

From this equation, it is understood that, even if P is varied while M and N are constant, a value of (M+P−N/K)×G can be reduced by adjusting K.

Energy required to move the elevator is obtained from an equation of work done to move the elevator. The work is expressed by the equation W=F×S (here, W is the work, and S is the distance moved by the force F. Unit of W:J, Unit of F:N, Unit of S:m). Therefore, energy consumption is proportional to F.

Because there may be some difficulty in understanding the process of saving energy only through the equations, the process will be explained through an example. In a building in which each floor has a height of 3.2 meters, a case of raising the cage to a tenth floor, that is, to 32 meters, will be explained. It is assumed that an acceleration at the moments of departure and arrival of the elevator is 2 m/sec², and the maximum speed of the elevator is 240 m/min (4 m/sec).

The elevator moves from the start position at an acceleration of 2 m/sec. After 2 seconds, the speed of the elevator reaches the maximum speed of 4 m/sec. Thereafter, the elevator is in uniform motion without acceleration. After 8 seconds from the start time, the elevator reaches the height of 28 m. From this time, the elevator is decelerated to 2 m/sec². Then, 10 seconds after the start time, the elevator reaches the height of 32 m and is stopped.

If this example is applied to the conventional elevator shown in FIG. 1, a result of the work done by the elevator is as follows:

first, from 0 to 2 seconds;

F1=(M+P+N)×2+(M+P−N)×9.8

W1=F1×4=(M+P+N)×8+(M+P−N)×39.2

from 2 to 8 seconds;

F2=(M+P+N)×0+(M+P−N)×9.8

W1=F2×24=(M+P−N)×235.2

from 8 to 10 seconds;

F3=(M+P+N)×(−2)+(M+P−N)×9.8

W3=F3×4=(M+P+N)×(−8)+(M+P−N)×39.2

and, the total work done from 0 to 10 seconds is

W=W1+W2+W3

=(M+P+N)×8+(M+P−N)×39.2+(M+P−N)×235.2+(M+P+N)×(−8)+(M+P−N)×39.2

=(M+P−N)×313.0.

Furthermore, if the conventional elevator is moved to a 5th floor, the total work calculated using the same equation is as follows.

W=(M+P−N)×156.8 (16 m)

As well, in the case of the 15th floor, the total work is

W=(M+P−N)×470.4 (48 m).

Meanwhile, if the above-mentioned example is applied to the elevator having the gears 7 and 8 of the gear ratio K according to the first embodiment of the present invention, the following numerical expressions are obtained.

In the case that the elevator moves to the 10th floor, that is, a distance of 32 m: W=(M+P−N/K)×313.6

In the case that the elevator moves to the 5th floor, that is, a distance of 16 m: W=(M+P−N/K)×156.8

In the case that the elevator moves to the 15th floor, that is, a distance of 48 m: W=(M+P−N/K)×470.4

To obtain a detailed result, on the assumption that the weight of each passenger is 60 kg and each of M and N is 1000 kg, the amount of energy requited to move 2 persons, 5 persons, 10 persons, 15 persons or 20 persons to the 5th, 10th or 15th floor was calculated, and the results are described in Table 1.

The unit is J (joules)

TABLE 1

| | 2 per- | 5 per- | 10 per- | 15 per- | 20 per- | Sum by |
|---|---|---|---|---|---|---|
| Section | sons | sons | sons | sons | sons | floors |
| 5th floor | 18816 | 47040 | 94080 | 141120 | 188160 | 489216 |
| 10th floor | 37632 | 94080 | 188160 | 282240 | 376320 | 978432 |
| 15th floor | 56448 | 141120 | 282240 | 423360 | 564480 | 1467648 |
| Sum | 112896 | 282240 | 564480 | 846720 | 1128960 | 2935296 |

Furthermore, when a value of N is changed into another value, that is, when it is assumed that the weight of each passenger is 60 kg, M is 1000 kg, and N is 1600 kg, the amount of energy required to move 2 persons, 5 persons, 10 persons, 15 persons or 20 persons to the 5th, 10th or 15th floor was calculated, and the results are described in Table 2.

TABLE 2

| | 2 per- | 5 per- | 10 per- | 15 per- | 20 per- | Sum by |
|---|---|---|---|---|---|---|
| Section | sons | sons | sons | sons | sons | floors |
| 5th floor | 75264 | 47040 | 0 | 47040 | 94080 | 263424 |
| 10th floor | 150528 | 94080 | 0 | 94080 | 188160 | 526848 |
| 15th floor | 225792 | 141120 | 0 | 141120 | 282240 | 796848 |
| Sum | 451584 | 282240 | 0 | 282240 | 564480 | 790272 |

From Table 2, in the case of 10 persons, the results are 0. The reason is that they are calculated merely using the physical equations on the assumption that energy is conserved without considering energy loss due to friction or the like. In this case, because the side of the cage 1 and the side of the weight balance 2 are in equilibrium, the component related to gravity becomes zero. Therefore, components related to an acceleration force required to start the elevator are offset by components related to a deceleration force required to stop the elevator, so that the results become zero. However, in actuality, energy is required even when accelerating the elevator and when decelerating it.

From this, it is appreciated that the sum greatly varies according to value of N.

The value of N cannot be easily changed during the operation of the elevator, but if N is set to an optimum value in consideration of the number of passengers who use the elevator at a time, energy consumption is reduced compared to the prior art.

Hereinafter, when the same calculation method, except for application of the gear ratio K, which differs according to the number of passengers, is applied to the elevator according to the first embodiment of the present invention, the amount of energy will be calculated. Here, it is assumed that the weight of each passenger is 60 kg and M is 1000 kg in the same conditions as those of the former tests, but, unlike the former tests, it is assumed that N is 2200 kg, K=2 in the case of 2 persons, K=1.7 in the case of 5 persons, K=1.4 in the case of 10 persons, K=1.2 in the case of 15 persons, and K=1 in the case of 20 persons. The results are described in Table 3.

TABLE 3

| | 2 per- | 5 per- | 10 per- | 15 per- | 20 per- | |
|---|---|---|---|---|---|---|
| | sons, | sons, | sons, | sons, | sons, | Sum by |
| Section | K = 2 | K = 1.7 | K = 1.4 | K = 1.2 | K = 1 | floors |
| 5th floor | 3136 | 941 | 4547 | 10506 | 0 | 19130 |
| 10th floor | 6272 | 1882 | 9094 | 21011 | 0 | 38259 |
| 15th floor | 9408 | 2822 | 13642 | 31517 | 0 | 57389 |
| Sum | 18816 | 5645 | 27283 | 63034 | 0 | 114778 |

Furthermore, when the number of passengers is changed under the same conditions of the test of Table. 3, the results are described in Table. 4.

TABLE 4

| | 3 per- | 7 per- | 11 per- | 14 per- | 18 per- | |
|---|---|---|---|---|---|---|
| | sons, | sons, | sons, | sons, | sons, | Sum by |
| Section | K = 2 | K = 1.7 | K = 1.4 | K = 1.2 | k = 1 | floors |
| 5th floor | 12544 | 19757 | 13955 | 1098 | 18816 | 66170 |
| 10th floor | 25088 | 39514 | 27910 | 2195 | 37632 | 132339 |
| 15th floor | 37632 | 59270 | 41866 | 3293 | 56448 | 198509 |
| Sum | 75264 | 118541 | 83731 | 6586 | 112896 | 397018 |

As described in Tables. 3 and 4, it is appreciated that, when a value of K is applied such that an absolute value of (M+P−N/K) is minimized, the elevator can be operated using minimum energy.

As described in the above example, when the conventional elevator consumes energy of 2935296 J and 1580544 J, the elevator according to the first embodiment of the present invention consumes energy of 114778 J and 397018 J. In other words, energy consumption of the conventional elevator is approximately 10 times more than that of the elevator of the first embodiment.

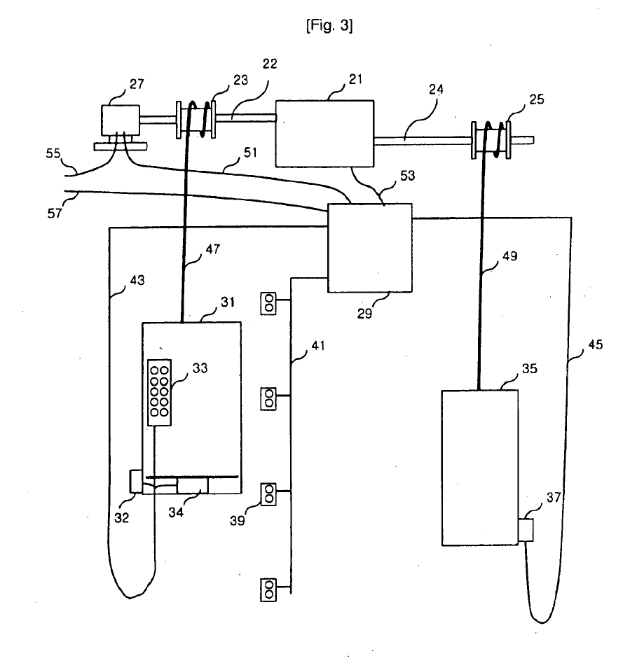

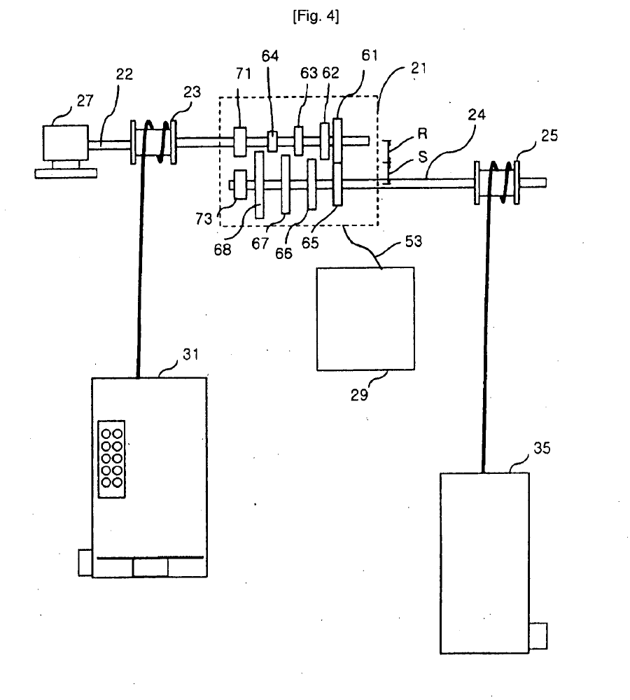

Meanwhile, an elevator according to a second embodiment of the present invention is characterized by a construction such that a value of K is variable. Referring to FIGS. 3 and 4, the elevator according to the second embodiment of the present invention includes a cage 31, a balance weight 35, a weight sensor 34, first and second winches 23 and 25, an electromotor 27, an electronic control transmission 21 and a control unit 29.

The cage 31, which is loaded with cargo or passengers, is connected to the first winch 23 through a wire rope 47. A position sensor 32 is provided on the cage 31 to detect the position of the cage 31. Furthermore, the weight sensor 34, which determines the weight sum of cargo and passengers loaded in the cage 31, is provided in the cage 31. The above-mentioned sensors 32 and 34 transmit sensing signals to the control unit 29.

The first winch 23 is coupled to and rotated by the electromotor 27. Therefore, when the electromotor 27 rotates in a direction, the first winch 23 is rotated in a direction to wind or unwind the wire rope 47, thus moving the cage 31 upwards or downwards. The electromotor 27 is controlled by the control unit 29 and has a structure such that the first winch 23 is rotatably coupled to a drive shaft 22 of the electromotor 27.

The balance weight 35 is coupled to the second winch 25 through a wire rope 49. The second winch 25 is coupled to a driven shaft 24. Therefore, according to the rotating direction of the driven shaft 24, the balance weight 35 is selectively moved upwards or downwards. A position sensor 37 is provided on the balance weight 35 to detect the position, that is, the height of the balance weight 35. A sensing signal of the position sensor 37 is transmitted to the control unit 29.

The drive shaft 22 and the driven shaft 24 are selectively coupled to each other by the electronic control transmission 21. As shown in FIG. 4, the electronic control transmission 21 includes a first brake 71, which is provided on the drive shaft 22, a second brake 73, which is provided on the driven shaft 24, a plurality of drive gears 61, 62, 63 and 64, which are provided on the drive shaft 22, and a plurality of driven gears 65, 66, 67 and 68, which are provided on the driven shaft 24. The drive gears 61, 62, 63 and 64 have different radii and are provided so as to be slidable along the drive shaft 22 under control of the control unit 29. Thus, one of the drive gears 61, 62, 63 and 64 engages with one of the driven gears 65, 66, 67 and 68, so that power is transmitted therebetween. The positions of the driven gears 65, 66, 67 and 68 are fixed to the driven shaft 24. Furthermore, the driven gears 65, 66, 67 and 68 are selectively connected to one of the drive gears 61, 62, 63 and 64. The first brake 71 and the second brake 73 are operated under the control of the control unit 29 and serve to stop the drive shaft 22 and the driven shaft 24 or release them such that they are rotatable. As an example, FIG. 4 shows a state in which the drive gear 61 and the driven gear 65, which have the same radius (R, S), engage with each other. As such, in this embodiment, the elevator has the electronic control transmission 21 which controls a gear ratio K under the control of the control unit 29. That is, the control unit 29 controls the electronic control transmission 21 to set the optimum gear ratio K so that minimum energy is consumed, in consideration of various variables shown in test examples of Tables. 3 and 4.

In detail, the control unit 29 controls the operation of the electromotor 27 and the electronic control transmission 21 using information transmitted from the sensors 32, 34 and 37. As shown in FIG. 3, the control unit 29 is connected to floor switches 39, which are provided on respective floors, through a signal connection wire 41. Furthermore, the control unit 29 is connected to an indoor switch unit 33, which is provided in the cage 31, through a signal connection wire 43 to receive signals from the indoor switch 33. In FIG. 3, the reference numeral 51 denotes a signal wire which connects the electromotor to the control unit 29, the reference numeral 53 denotes a signal wire which connects the electronic control transmission 21 to the control unit 29, the reference numeral 45 denotes a signal wire which connects the position sensor 37 to the control unit 29, and the reference numerals 55 and 57 denote power wires.

In the case of the elevator having the above-mentioned construction, the control unit 29 receives a signal from a floor switch 39 or the indoor switch 33 and then determines the direction in which the elevator moves and target floors at which the elevator is subsequently stopped. Thereafter, the control unit 29 selects gears of the electronic control transmission 21 which engage with each other with reference to both a weight of the cage and position information of the balance weight 35. Subsequently, the control unit 29 controls the electromotor 27 and thus moves the cage 31 to the subsequent target floor. The detailed operation of the electronic control transmission 21 is as follows. When the electronic control transmission 21 receives the order of a gear shift from the control unit 29, the shafts 22 and 24, which are respectively coupled to the winches 23 and 25, are stopped by the brakes 71 and 73. Thereafter, the sliding gears 61, 62, 63 and 64 are shifted to the desired position. After the gear shift has been completed, the brakes 71 and 73 are released.

As described above, in the elevator according to the second embodiment of the present invention, because the electronic control transmission 21 is provided, force of the balance weight applied to the cage 31 can be changed according to weight of passengers and cargo during the operation of the elevator, without a change in the weight of the balance weight. This performance has the same effect as that of a change in the weight of the balance weight.

Meanwhile, in the case of the second embodiment of the present invention, it is difficult to control the value of K such that an absolute value of (M+P−N/K) is minimized. In detail, as a value of K is increased, a distance that the balance weight 35 moves is reduced. Furthermore, the ratio of the distance that the balance weight 35 with respective to the distance that the cage 31 moves differs depending on the value of K. Therefore, the present position of the balance weight 35 may be a position at which the optimum value of K cannot be applied. Accordingly, actually, the value of K, which changes depending on the position of the cage 31 and the weight balance 35, the number of passengers and desired target floors of the passengers, may differ from a theoretical value. Thus, in the second embodiment of the present invention, it must be appreciated that an amount of substantially saved power consumption is smaller than a value resulting from a theoretical test.

Meanwhile, in the second embodiment of the present invention, a reduction of energy consumption that is required to operate the elevator is realized by the construction such that the balance weight 35 stores potential energy and uses merely an appropriate amount of energy when it is necessary. For example, in the conventional elevator, when a cage 1 which is in a state of being fully loaded with passengers moves front the lowermost floor to the uppermost floor, a balance weight 2 is conversely moved from the uppermost floor to the lowermost floor. Subsequently, if the vacant cage 1 moves from the lowermost floor to the uppermost floor, the balance weight 2 is moved from the uppermost floor to the lowermost floor. During this process, the potential energy, which has been stored by movement of the balance weight 2 to the uppermost floor, is wasted in the subsequent movement of the balance weight 2. Meanwhile, cargo and passengers are also moved downwards as much as they move upwards, but, because the order in which they move upwards or downwards is mixed, the balance weight 2 must have the ability of storing great potential energy.

Therefore, in the elevator according to the second embodiment of the present invention, to enhance the ability of storing potential energy of the balance weight 35, it is preferable that the weight of the balance weight 35 be increased, and a moving distance of the balance weight 35 be reduced by increasing the gear ratio K. On the assumption that the weight N of the balance weight 35 is 11000 kg, the same calculation as that in the former tests is executed, but different gear ratios K according to the number of passengers are applied. Furthermore, it is assumed that the weight of each passenger is 60 kg and M is 1000 kg under the same conditions as those of the former tests, but, unlike the former tests, the calculation is executed under the conditions in which K=2 in the case of 2 persons, K=9 in the case of 5 persons, K=7 in the case of 10 persons, K=6 in the case of 15 persons, and K=5 in the case of 20 persons. The result are described in Table 5.

TABLE 5

| | 2 per- | 5 per- | 10 per- | 15 per- | 20 per- | |
|---|---|---|---|---|---|---|
| | sons, | sons, | sons, | sons, | sons, | Sum by |
| Section | K = 10 | K = 9 | K = 7 | K = 6 | K = 5 | floors |
| 5th floor | 3136 | 12230 | 4547 | 10506 | 0 | 30419 |
| 10th floor | 6272 | 24461 | 9094 | 21011 | 0 | 60838 |
| 15th floor | 9408 | 36691 | 13642 | 31517 | 0 | 91258 |
| Sum | 18816 | 73382 | 27283 | 63034 | 0 | 182515 |

Furthermore, when the number of passengers is changed, the results are described in Table. 6.

TABLE 6

| | 3 per- | 7 per- | 11 per- | 14 per- | 18 per- | |
|---|---|---|---|---|---|---|
| | sons, | sons, | sons, | sons, | sons, | Sum by |
| Section | K = 9 | K = 7 | K = 7 | K = 6 | K = 5 | floors |
| 5th floor | 6586 | 23677 | 13955 | 1098 | 18816 | 64131 |
| 10th floor | 13171 | 47354 | 27910 | 2195 | 37632 | 128262 |
| 15th floor | 19757 | 71030 | 41866 | 3293 | 56448 | 192394 |
| Sum | 39514 | 142061 | 83731 | 6586 | 112896 | 384787 |

As understood from the above tests, energy consumption of each case is similar, but a moving distance of the balance weight 35 can be reduced by increasing the gear ratio K. Therefore, when selecting the gear ratio K during the operation of the elevator, there is an advantage in that the remaining distance that the balance weight 35 is allowed to move is increased.

In detail, in the case of the elevator of FIG. 1, the position of the balance weight 2 is determined by the position of the cage 1. The distances that they are moved are always equal to each other, because they are coupled to each other merely using the wire rope wrapped around the pulley 3.

In the case of use of the gears of FIG. 2, when a gear ratio of the gear 9 related to the balance weight 12 to the gear 7 related to the cage 11 is designated by K, the gear ratio for maintaining a weight balance and distances that the cage 11 and the balance weight 12 move according to the gear ratio are compared as follows.

K=E/D

(M+P)×E=N×D, (when F=0, A=0)

E/D=N/(M+P), so that

K=N/(M+P). From this, it is understood that the gear ratio K for maintaining a weight balance is varied by the weight P of passengers which frequently varies, and the gear ratio K is increased in proportion to the increase of the weight N of the balance weight 12. When the distance that the cage 11 is moved is C, and when the distance that the balance weight 12 is moved is Y,

*C:Y=E:D

Y=C×D/E

Y=C/K.

From this, it can be appreciated that, as the gear ratio K is increased, the distance Y that the balance weight 12 is moved is reduced. If the gear ratio K is varied during the operation of the elevator, because the distance that the balance weight 12 moves relative to the distance that the cage moves is changed every time the gear ratio K is varied, the position of the balance weight 12 is not determined by the position of the cage 11. Furthermore, the distances that they are moved are irrelevant to each other, and are varied depending on variation of the gear ratio K.

As such, in the present invention, the position of the balance weight 35 is not determined by the position of the cage 31, and the distance that it is moved is varied according to a selected gear. When realizing that the position of the balance weight 35 and the distance that it is moved are respectively independent from the position of the cage 31 and the distance that the cage 31 is moved, it can be appreciated that one cannot only consider the weight balance when selecting the gear. For example, in the elevator of FIG. 4, which is operated between the 1st floor and the 10th floor, when it is assumed that the cage 31 is placed at the 1st floor while the balance weight 35 is placed at the 5th floor, and the cage 31 is fully loaded with passengers at the 1st floor, if only the weight balance is considered, the elevator should be operated in a statue in which the gear ratio is lowest. That is, the largest drive gear 61, which is provided on the drive shaft 22 of the winch 23 related to the cage 31, should be coupled to the smallest driven gear 65, which is provided on the driven shaft 24 of the which 25 related to the balance weight 35. In the electronic control transmission 21 of FIG. 4, in this case, because the diameter R of the gear 61 is equal to the diameter S of the gear 65, the distance that the cage 31 is moved becomes equal to the distance that the balance weight 35 is moved. If the destination of the passengers is the 5th floor, the elevator can be operated in the above state. However, if the destination of the passengers is the 10th floor, because the distance that the cage 31 moves is longer than the distance from the 5th floor to the 1st floor, that is, the maximum distance that the balance weight 35 is allowed to move, the gear ratio must be changed. In detail, because the distance that the balance weight 35 moves is reduced as a larger gear of the gears related to the balance weight 35 is selected, the diameter S of the gear related to the balance weight 35 must be at least 2 times the diameter R of the gear related to) the cage 11, for example, the gears 63 and 67 may engage with each other. As such, in the case that the gear, having the diameter S which is two times the diameter R, engages with the gear having the diameter R, while the cage 31 is moved from the 1st floor to the 10th floor, the balance weight 35 is moved from the 5th floor to the 1st floor. Here there is a problem in that, because a weight balance is not realized between the side of the cage 31 and the side of the balance weight 35, the electromotor 27 must consume greater energy. As described above, if the elevator can be operated in a state in which the weight of the balance weight 35 and the gear ratio are relatively large, cases in which the distance that the balance weight 35 is moved can be reduced and a gear ratio corresponding to the weight balance can be realized are frequent, so a difficulty in operating the elevator is reduced and energy is saved.

Of the above equations, the equation related to the gear ratio realizing the weight balance is again written and explained as follows:

K=N/(M+P).

As shown in this equation, the gear ratio K, which realizes the weight balance, is varied according to a change in the weight P of passengers. However, actually, in the electronic control transmission 21, because it can realize merely several predetermined gear ratios, a gear ratio equal to the result from the above equation is not always applied but gear engagement corresponding to an approximate value of the result is selected. Furthermore, the equation related to distances that the cage 11 and the balance weight 12 are moved according to a gear ratio is as follows:

Y=C/K.

This equation may be expressed as the following equation.

K=C/Y

This equation serves to calculate a gear ratio K based on a desired distance that the cage 11 is moved and a desired distance that the balance weight 12 is moved. As in the example described above, even when the gears must be selected using a ratio of a desired distance that the cage 11 is moved with respect to the remaining distance that the balance weight 12 is allowed to move, without considering weight balance, a substantial gear ratio K cannot be set into a value equal to the result of the above equation, but a gear ratio which is most approximate to the result must be selected, because the gear ratios to be selected in the electronic control transmission are limited to merely several limited values. Such problems can be solved by use of an electronic control transmission of a continuously variable-type transmission. That is, even when selecting a gear ratio in consideration of the weight balance, the continuously variable-type transmission makes it possible for a gear ratio equal to the result from the above equation to be applied, without selecting an approximate value as the gear ratio. Furthermore, even when selecting a gear ratio based on the moving distances, the continuously variable-type transmission makes it possible for a gear ratio equal to the result from the equation to be applied, without selecting an approximate value as the gear ratio. Therefore, the continuously variable transmission can further reduce energy consumption.

### MODE FOR THE INVENTION

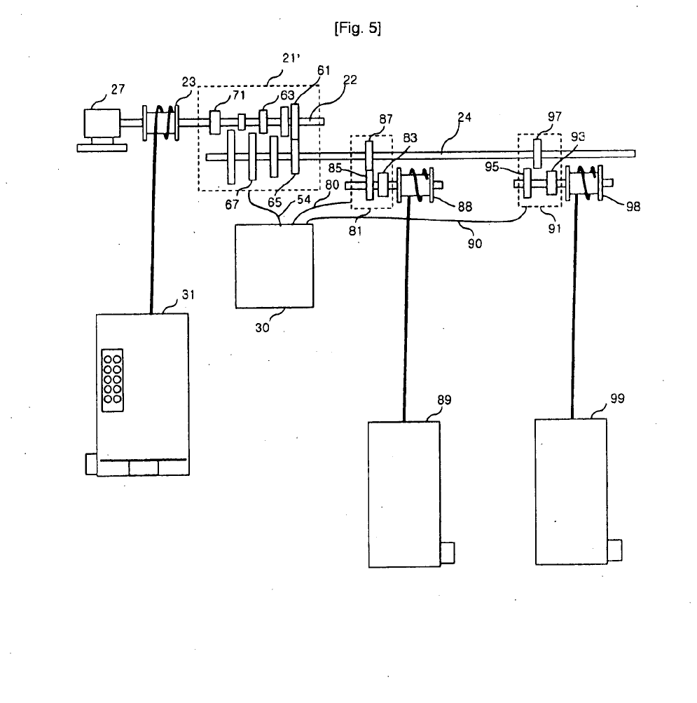

In FIG. 5, an elevator according to a third embodiment of the present invention is illustrated. Referring to FIG. 5, in this embodiment, a drive shaft 22, on which a first winch 23 is provided, is connected to a driven shaft 24 through an electronic control transmission 21′. Furthermore, second and third winches 88 and 98 are coupled to the driven shaft 24 through first and second electronic control clutches 81 and 91. As well, balance weights 89 and 99 are respectively coupled to the second and third winches 88 and 98 using wire ropes.

The electronic control transmission 21′ and the first and second electronic control clutches 81 and 91 are operated under the control of a control unit 30. As such, in this embodiment, the plurality of balance weights 89 and 99 are coupled to the respective winches 88 and 98 and to the respective electronic control clutches 81 and 91. Therefore, the balance weights can be selectively used when the elevator is operated.

Here, the first electronic control clutch 81 includes a stationary gear 87, which is provided on the driven shaft 24, and a sliding gear 85 and a brake 83, which are provided on a shaft of the second winch 88. The sliding gear 85 is selectively coupled to or decoupled from the stationary gear 87 under the control of the control unit 30. The second electronic control clutch 91 includes a stationary gear 97, which is provided on the driven shaft 24, and a sliding gear 95 and a brake 93, which are provided on a shaft of the third winch 98. In this construction, the electronic control transmission 21′ does not require a separate brake on the driven shaft 24. The general construction of the electronic control transmission 21′, except for the brake, remains the same as the electronic control transmission 21 of FIG. 4.

In the elevator having the above-mentioned construction, for example, if only one balance weight 89 is selected, two gears 85 and 87, which are provided in the first electronic control clutch 81 coupled to the second winch 88 of the balance weight 89, engage with each other. On the other hand, two gears 95 and 97, which are provided in the second electronic control clutch 91 coupled to the third winch 98 of the balance weight 99 that is not selected, are in a neutral state, and the brake 93 is in a state of being operated. Both a brake 71, which is provided on the drive shaft 22 in the electronic control transmission 21′, and the brake 83, which is provided in the electronic control clutch 81 coupled to the selected balance weight 89, are operated when the electronic control transmission 21′ is in a neutral state or when a signal is received from the control unit 30, such that the cage 31 and the balance weight 89 are not moved. In the case that movement of passengers is concentrated in one direction, as in morning or evening rush hours, the selected balance weight 89 is moved to the uppermost or lowermost floor so that it may not be able to be executed to balance the weight. At this time, the other balance weight 99 is selected, such that it serves to balance the weight of the cage 31. In this embodiment, two balance weights 89 and 99 are used as an example, but, of course, three or more balance weights may be used.

From a dynamic point of view, if people are mainly moving to upper floors, the balance weights 89 and 99 are gradually moved downstairs. If people are mainly moving to lower floors, the balance weights 89 and 99 are gradually moved towards the uppermost floors, thus storing potential energy. As such, the potential energy is conserved by the balance weights 89 and 99, while the elevator is operated in the same manner as that of a pulley mechanism which is in a balanced state. In FIG. 5, the reference numerals 54, 80 and 90 denote signal wires.

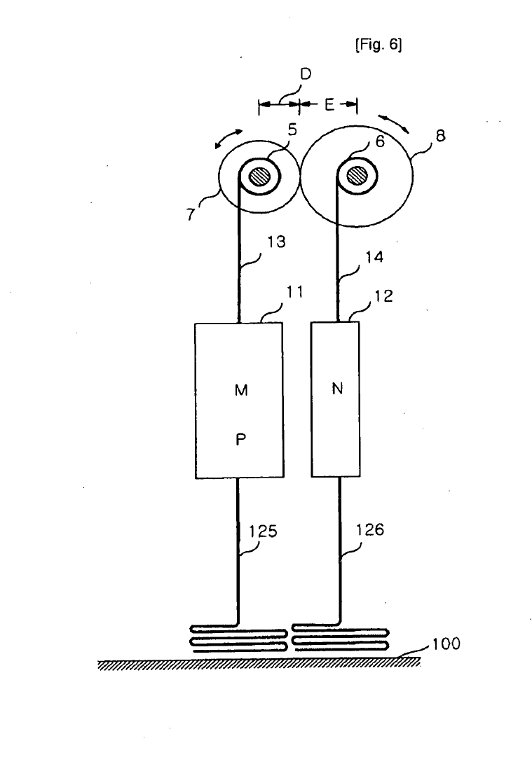

FIG. 6 is a schematic view showing an elevator according to a fourth embodiment of the present invention. Referring to FIG. 6, this embodiment is constructed such that wire ropes 125 and 126 are respectively coupled to the lower ends of the cage 11 and the balance weight 12 and contact the bottom of the building. In the case of a multistoried building, because variation of distances between winches 5 and 6 and the cage 11 and the balance weight 12 is great, variation of the weights of wire ropes 13 and 14 cannot be disregarded. Therefore, in this embodiment, the wire ropes 125 and 126, which are the same as the wire ropes 13 and 14 coupled to the winches 5 and 6, are coupled to the lower ends of the cage 11 and the balance weight 12 and contact the bottom of the building, so that, even if the positions of the cage 11 and the balance weight 12 are changed, the weights applied to the winches 5 and 6 become constant. Even in a conventional elevator, a balance rope is used. In the case of the conventional elevator, because the position of the cage is dependent on the position of the balance weight, the conventional elevator may be constructed such that the balance rope does not contact the bottom of the building using a balance pulley. Furthermore, it may be operated in a state in which the overall length of the balance rope is shorter than the height of the building. However, in the elevator of the present invention; because the position of the cage 11 is independent from the position of the balance weight 12, the conventional method can no longer be applied to the present invention. The fourth embodiment of the present invention means to solve the above problem.

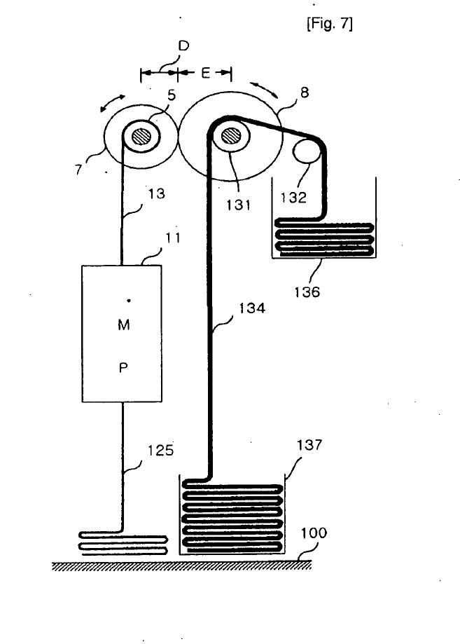

FIG. 7 is a schematic view illustrating an elevator according to a fifth embodiment of the present invention. This embodiment substitutes a chain or a chain structure weight 134, which is manufactured by connecting a plurality of heavy bars, for the balance weight 12 and the winch 6 of the balance weight 12. The chain structure weight 134 has an advantage in that it can be installed in a space which is required for installation of a balance weight in the conventional elevator. As shown in FIG. 7, containers 137 and 136 are respectively provided on the bottom 100 and at the top of the building, so that some of the chain or chain structure weight 134 is stacked in the containers. At this time, a portion of the chain or chain structure weight 134 from the bottom of the building to a shaft of a wheel unit 131, except for a height of some chain or chain structure weight 134 stacked in the lower container and except for a height from some chain or chain structure weight 134 stacked in the upper container to the shaft of the wheel unit 131, serves as a balance weight. Compared to the method of FIG. 5 which uses the two balance weights 89 and 99, there is no trouble of switching the connection of the balance weights during the operation of the elevator.

The operation of this embodiment will be explained through a simple example. It is assumed that there is a building with ten floors, each having a height of 3 m, and 20 persons, each having a weight of 50 kg, work on each floor. Furthermore, it is assumed that all people are on the job in the morning and leave their work in the evening. When all people are on the job, the increased amount of potential energy is as follows.

50 kg×20=1000 kg

1000×3×1+1000×3×2+1000×3×3+1000×3×4+1000×3×+1000×3×6+1000×3×7+1000×3×8+1000×3×9=135000 kgfm. When all people leave their work, the potential energy of 135000 kgfm is reduced. Here, a device capable of storing the increased potential energy is required.

135000/(9×3)=5000 kg

That is, when a weight of 5000 kg is placed at the 10th floor, the total potential energy can be conserved. If a chain structure weight 134, having a weight of 200 kg per 1 m, is used, 25 m of the chain structure weight 134 must be placed in the upper container 136, and 27 m of the chain structure weight 134, which corresponds to the height of the building, must be suspended. Therefore, when the chain structure weight 134 has a length of 52 m, the elevator can be operated while conserving the potential energy. The weight of a portion of the chain structure weight serving as a balance weight is approximately 200 kg×27=5400 kg. Then, a gear ratio of the electronic control transmission is determined in consideration of the weight of the cage 11. That is, on the assumption that the weight of the cage 11 is 1350 kg and the cage 11 call be loaded with passengers to a maximum of 1350 kg, it must be constructed such that the gear ratio can be varied into several levels between 4:1 and 2:1. An amount of increased potential energy, the height of the building, the weight of the cage, the maximum number of passengers, etc. are points to be duly considered when determining required weight of the chain structure weight 134 per length.

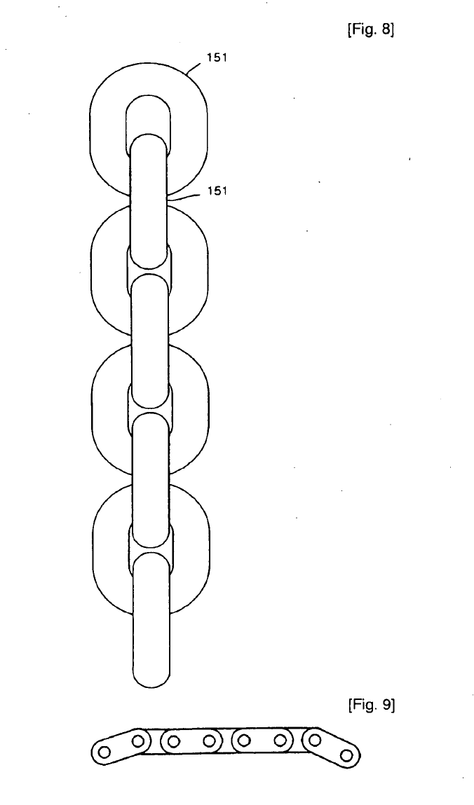

FIG. 8 illustrates a chain 151 which is an example of the chain structure weight 134 of FIG. 7. The chain 151 is made of metal and has a predetermined thickness.

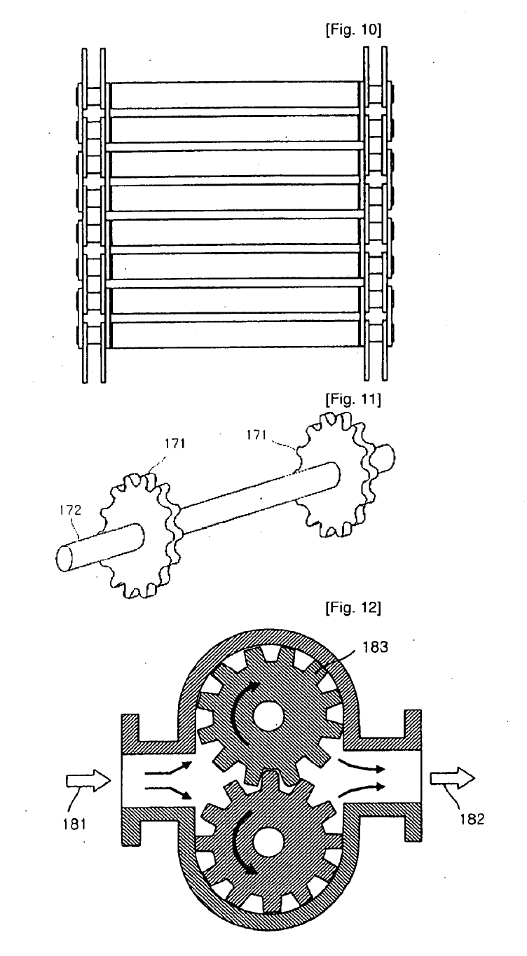

FIGS. 9 and 10 illustrate another example of the chain structure weight 134. This chain structure weight includes a plurality of bars, each having a predetermined length and weight, and chain rollers, each of which has a predetermined length and rotatably supports each of the opposite ends of the bars. Furthermore, an example of the wheel unit 131 which moves the chain structure weight 134 is shown in FIG. 11. Referring to FIG. 11, the wheel unit has a construction in which two sprocket wheels 171 are provided on a shaft 172 such that they are spaced apart from each other by a predetermined distance. The chain structure weight 134 of FIGS. 9 and 10 uses the chain rollers as an example. Alternatively, wire ropes may be used in place of the chain rollers.

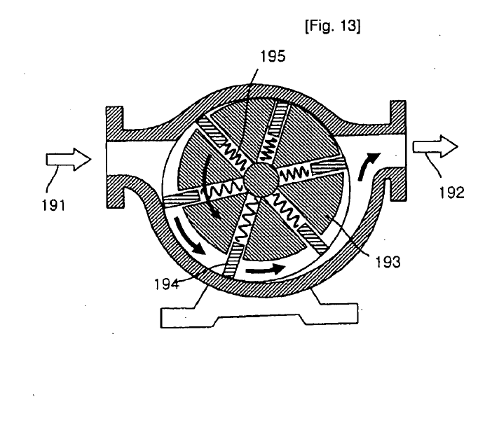

FIG. 12 shows a gear pump which is a kind of rotary pump. FIG. 13 shows a vane pump. These can serve as both a hydraulic pump and a hydraulic motor. According to use and structure, these are called a gear pump or a gear motor and a vane pump or a vane motor. In FIG. 12, the reference numeral 181 denotes an inlet side, 182 denotes an outlet side, and 183 denotes a gear. In FIG. 13, the reference numeral 191 denotes an inlet side, 192 denotes an outlet side, 193 denotes a rotor, 194 denotes a vane, and 195 denotes a spring. The gear motor and vane motor having the above-mentioned constructions are well known in the related art and are generally used, therefore further explanation is deemed unnecessary.

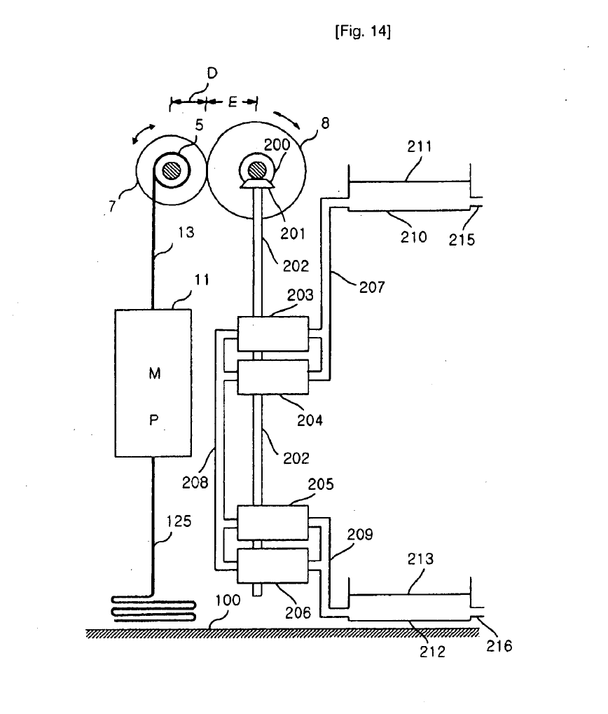

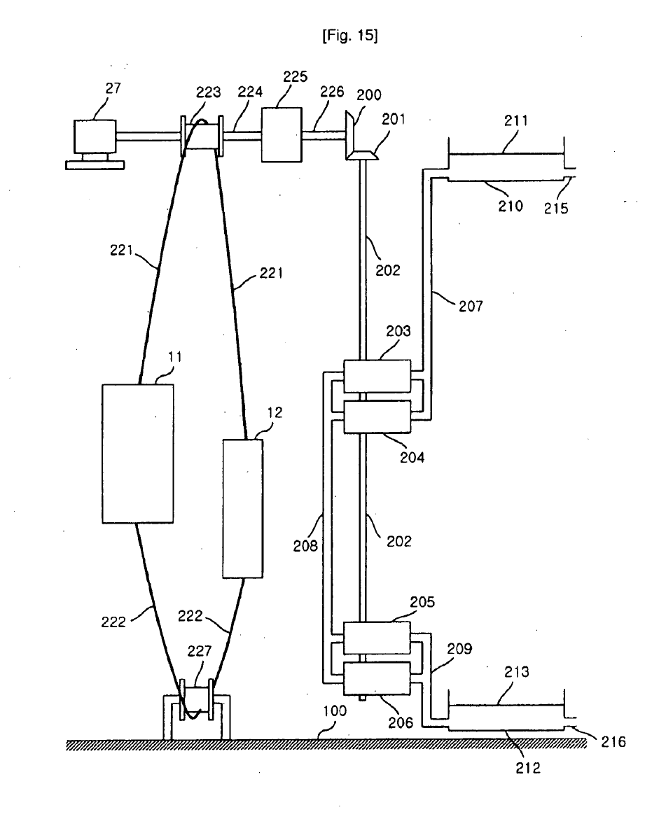

FIG. 14 is a view showing an elevator according to a sixth embodiment of the present invention. Here, a substitution of a load-applying device, which uses liquid and hydraulic motors 203, 204, 205 and 206, for the balance weight 35 and the balance weight winch 25 of the elevator of FIG. 3, will be explained in detail herein below. Furthermore, in the case of the elevator of FIG. 6, the load-applying device substitutes for the balance weight winch 6 and the wire rope 126, which is coupled to the lower end of the balance weight 12 and contacts the bottom of the building.

Here, the hydraulic motors 203, 204, 205 and 206 must be able to alternately serve as a hydraulic motor and a hydraulic pump, as the gear motor of FIG. 12. Furthermore, in the hydraulic motors 203, 204, 205 and 206, a discharge rate must be in proportion to the number of revolutions of the shaft of the hydraulic motor, as the gear motor of FIG. 12. The rotating force of the hydraulic motor is proportional to the pressure of liquid and to a discharge amount per unit revolution thereof. In other words, as the pressure applied to the hydraulic motor is increased, and as the capacity of the hydraulic motor is increased, the rotating force thereof is increased.

As such, this embodiment of the present invention comprises the plurality of hydraulic motors. The hydraulic motors are connected to each other by at least one method of serial and parallel connection methods.

The serial connection of the hydraulic motors 203, 204, 205 and 206 has a similar effect to that of a serial connection method of batteries to increase voltage. In the case that a difference in height between a lower liquid tank 212 and an upper liquid tank 210 is great, the entire pressure of liquid may be distributed such that the distributed pressures are applied to the respective hydraulic motors 203, 204, 205 and 206. Furthermore, they may raise liquid to a higher location. In detail, to achieve the above purposes, the hydraulic motors 203, 204, 205 and 206 are disposed at positions at which a distance between the lower liquid tank 212 and the upper liquid tank 210 is divided into two or three equal parts. Liquid pipes 207, 208 and 209 are connected to the hydraulic motors 203, 204, 205 and 206. Thereafter, a rotating shaft 202 is coupled to the hydraulic motors. The rotating force of the rotating shaft 202 coupled to the hydraulic motors is equal to the sum of rotating forces of the hydraulic motors.

The parallel connection of the hydraulic motors 203, 204, 205 and 206 has a similar effect to that of a parallel connection method of batteries to increase electric current. The hydraulic motors 203, 204, 205 and 206 are disposed at positions at which the pressure of liquid is the same. A rotating shaft 202 is coupled to the hydraulic motors. Furthermore, liquid pipes 207, 208 and 209 are coupled to the hydraulic motors 203, 204, 205 and 206. Here, the rotating force of the rotating shaft 202 is equal to the sum of rotating forces of the hydraulic motors 203, 204, 205 and 206. That is, a liquid discharge rate per unit revolution of the rotating shaft 202 is increased in proportion to the number of hydraulic motors 203, 204, 205 and 206 which are connected in parallel with each other. Because the hydraulic motors 203, 204, 205 and 206 of FIG. 14 are coupled to the rotating shaft 202, the rotating force of the rotating shaft 202 is equal to the sum of rotating forces of the hydraulic motors 203, 204, 205 and 206. Here, a bevel gear 201 is provided on an end of the rotating shaft 202. The bevel gear 201 is coupled to a bevel gear 200 which is provided on the shaft of a driven shaft of an electronic control transmission, that is, on the shaft of the stationary gear 8. In FIG. 14, the reference numerals 211 and 213 denote the surface of the liquid. The reference numerals 215 and 216 denote pipes which are coupled to hydraulic motors of another elevator. That is, the liquid contained in the liquid tanks 210 and 212 may be used in another elevator.

The elevator is constructed such that the liquid pressure defined between the upper liquid tank 210 and the lower liquid tank 212 is distributed through the serial connection of the hydraulic motors 203, 204, 205 and 206, and such that rotating force sufficient to serve as the balance weight is ensured through the parallel connection. The hydraulic motors 203, 204, 205 and 206, which are installed as described above, provide constant rotating force, because hydraulic pressure is constant. Furthermore, the rotating force acts in constant magnitude and direction regardless of a flow direction of liquid and regardless of a direction in which the rotating shaft 202 is rotated. This is like that, every time an object is lifted or lowered, constant gravity is applied to the object. The rotating shaft 202, which is coupled to the hydraulic motors, is coupled to a cage winch 5 through gears 7 and 8 which engage with each other in the electronic control transmission. According to a direction in which an electromotor 27 rotates, a direction in which the cage 11 is moved, a direction in which the rotating shaft 202 is rotated, and a direction in which the liquid flows, are determined. When passengers move upwards, the liquid moves downwards, and, when passengers move downwards, the liquid moves upwards. According to the weight of passengers, the gears 7 and 8, which engage with each other in the electronic control transmission, may be shifted. Even when the cage 11 is moved at a constant speed, a relative speed of the rotating shaft 202 may be changed depending on a gear shift. Preferably, as the number of passengers is increased, a flow speed of liquid is increased through the shifting of the gears.

If it is assumed that the hydraulic motors and the electronic control transmission are ideal devices so that there is no energy loss, a change in potential energy by movement of passengers is converted into a change in potential energy of liquid. The general equation for potential energy is expressed as follows:

M×G×H

(M: weight, G: gravitational acceleration, H: height)

If ten passengers, each having a weight of 70 kg, are lifted to a height of 10 m, potential energy of 7000 kgfm is increased. Furthermore, if a height difference between the lower liquid tank 212 and the upper liquid tank 210 is 100 m and liquid of 1 L (liters is 1 kg, liquid of 70 L falls down (70×1×100=7000 kgfm). If the same number of passengers move in the opposite direction, liquid of 70 L is moved upwards. As such, in this device, a change in potential energy of passengers is converted into a change in potential energy of liquid, such that the potential energy can be stored and reused. In the above example, the weight of the cage 11 has not been considered. The operation of the elevator in consideration of the weight of the cage 11 will be explained herein below. The cage 11, which is moved upwards and downwards, has a constant weight, so that effect of movement of the cage 11 is always offset by the movement of liquid, corresponding to the cage 11. However, because a sufficient amount of liquid corresponding to the weight of the cage 11 must be moved upwards and downwards, the capacities of the hydraulic motors 203, 204, 205 and 206 should be as large as that, or the rotating speed of the rotating shaft 202 should also be increased as much as that. As well, the liquid tanks 210 and 212 should be as large as that.

To reduce these burdens while the variable potential energy of passengers is converted into potential energy of liquid, such that the energy can be stored and reused, a balance weight may be used along with the hydraulic motors. An elevator using this method is shown in FIG. 15.

FIG. 15 is a schematic view showing the elevator according to a seventh embodiment of the present invention. Referring to FIG. 15, a balance weight 12 and a cage 11 are connected to each other through wire ropes 221 and 222. The wise ropes 221 and 222 are respectively supported by a winch 223 and a balance pulley 227. The winch 223 is provided on a drive shaft 224 of an electromotor. A driven shaft 226, which is provided with a bevel gear 200 at an end thereof, is coupled to the drive shaft 224 through an electronic control transmission 225. Furthermore, in this embodiment, a load-applying device, which applies a load to the bevel gear 200, has the same construction as that shown in FIG. 14. In detail, the bevel gear 200 engages with a bevel gear 201 which is provided on a rotating shaft 202 coupled to gear pumps 203, 204, 205 and 206. When the gear pumps 203, 204, 205 and 206 are operated, liquid is moved between an upper liquid tank 210 and a lower liquid tank 212 through pipes 207, 208 and 209.

In this construction, the cage 11 has a constant weight, and the weight of the cage 11 is offset by the balance weight 12. Furthermore, a variable weight of passengers is offset using the hydraulic motors 203, 204, 205 and 206, liquid and electronic control transmission 225. As such, the elevator of FIG. 14 has a simple structure, but requires hydraulic motors and liquid tanks which have large capacities. Compared to the elevator of FIG. 14, the elevator of FIG. 15 has a complex structure, but the hydraulic motors 203, 204, 205 and 206 and the liquid tanks 210 and 212 thereof may have relatively small capacities.

Meanwhile, there is a variable capacity motor which can serve as both a transmission and a hydraulic motor. Therefore, if a variable capacity motor which can be electronically controlled is used, because it can execute the same function as that of the electronic control transmission, the elevator may be constructed without the electronic control transmission.

In the case that several elevators are provided in a building, they may use, in common, the upper and lower liquid tanks 210 and 212.

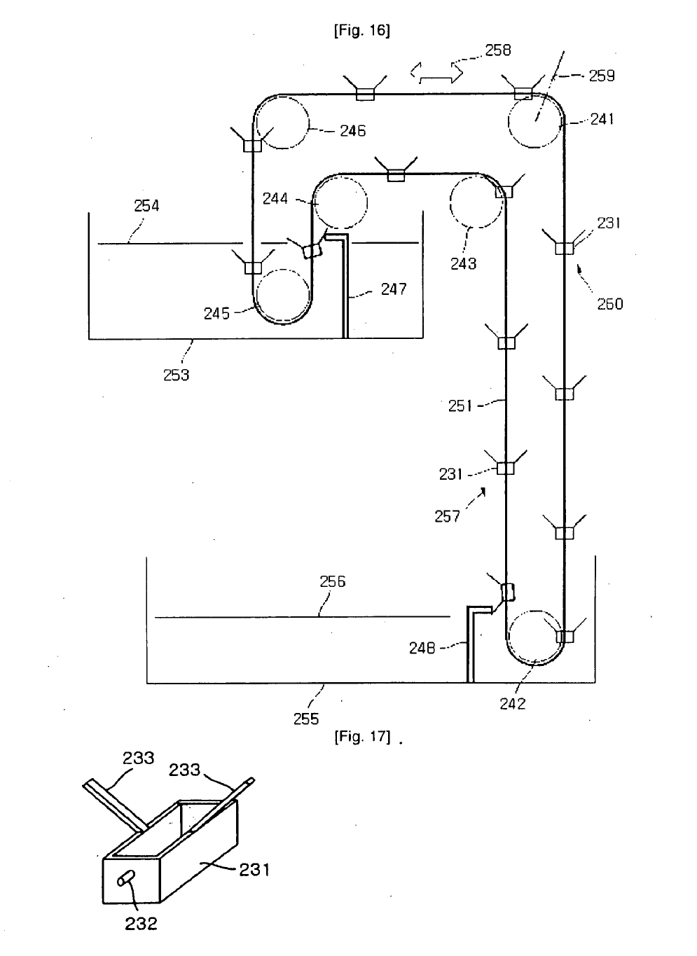

In the case of the elevator of FIG. 15, the balance weight 12 is used in the same manner as that of the conventional elevator, so that the weight of the cage 11 is offset by the balance weight 12. Furthermore, the elevator of FIG. 15 is characterized in that a variable weight of passengers is offset using the hydraulic motors 203, 204, 205 and 206, liquid and electronic control transmission 225. As such, the method of auxiliary, using the balance weight 12 may be applied both to the case of FIG. 7, which uses the chain or chain structure weight and the electronic control transmission, and to a case which uses a bucket conveyor of FIG. 16 and an electronic control transmission, and will be explained herein below.

FIG. 16 shows the bucket conveyor. Bucket, 231, 257, 260 moves along roller chains 251. The roller chains 251 can be moved in both directions, as designated by the arrow 258 of the drawing. When the roller chains 251 are moved to the right of the arrow 258 of FIG. 16, liquid is carried from an upper liquid tank 253 to a lower liquid tank 255. In detail, when each bucket 260 passes through a subsidiary wheel 245, liquid is contained in the bucket 260, and, thereafter, it is lifted. Subsequently, the bucket 260 containing liquid passes through a subsidiary wheel 246 and a sprocket wheel 241. After the bucket 260 passes through a subsidiary wheel 242, when a protruding rod 233 (see, FIG. 17) of the bucket 231 is caught by a stop plate 248, liquid is poured out of the bucket 231 into the lower liquid tank.

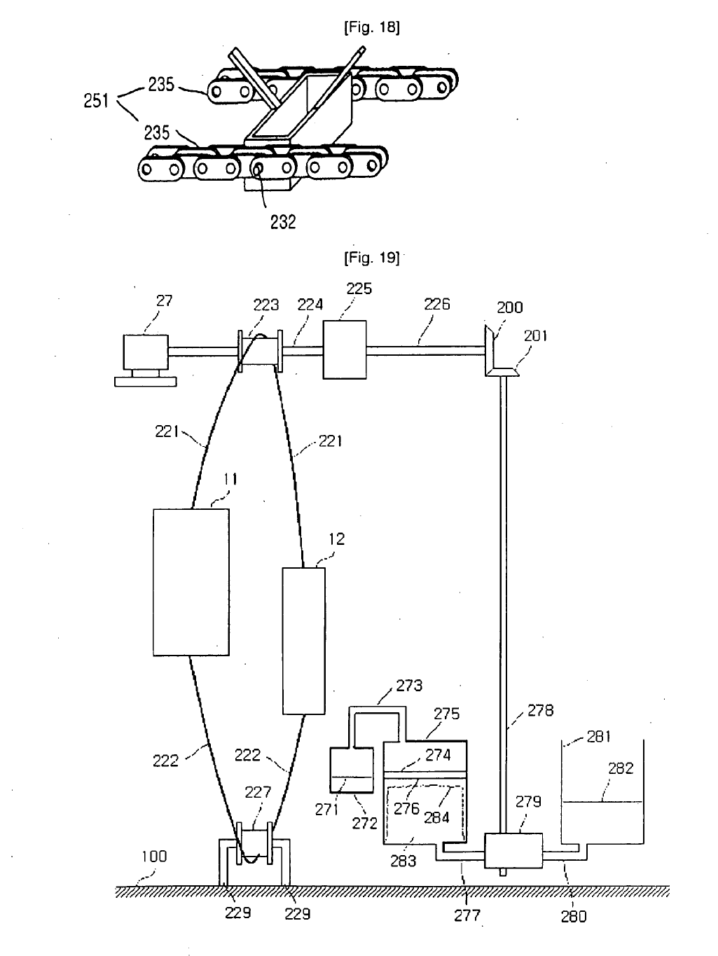

Here, a pair of protruding rods 233 is provided on each bucket 231. Rotating pins 232 are provided on opposite ends of each bucket 231. The rotating pins 232 are rotatably supported on the respective roller chains 251, as shown in FIG. 18.

Meanwhile, if the roller chains 251 are moved to the left of the arrow 258 of FIG. 16, liquid is carried from the lower liquid tank 255 to the upper liquid tank 253. This process will be explained herein below. When each bucket 231 passes under the subsidiary wheel 242 and moves towards the sprocket wheel 241, liquid is put into the bucket 231. The bucket 241 containing liquid consecutively passes through the sprocket wheel 241 and the subsidiary wheels 246 and 245. Thereafter, when the bucket 231 containing liquid is moved towards a subsidiary wheel 244, the protruding rod 233 of the bucket 231 is caught by a stop plate 247, thereby the liquid is poured out of the bucket 231 into the upper liquid Lank. As such, the direction in which liquid is carried is determined according to a rotating direction of the roller chain 251.

Here, because a large number of buckets 231 containing liquid is supported by the sprocket wheel 241, large rotating force is applied to the sprocket wheel 241. The technique using this rotating force may be applied to the various models of elevator described above. For example, in the case of FIG. 7, the sprocket wheel 241 of FIG. 16 may be used in place of the wheel unit 131. In these two drawings, they have the same function, and only rotating directions are opposite. Furthermore, if a bevel gear is provided on a shaft of the sprocket wheel 241 of FIG. 16 and is coupled to the bevel gear 200 of the elevator of FIG. 14 or 15, the device of FIG. 16 may substitute lot the hydraulic pump structure. Here, when comparing the method of using the hydraulic motors 203, 204, 250 and 206 to the method of using the bucket conveyor, it can be appreciated that they have the same principle, in which potential energy is stored by carrying liquid to a higher location. Merely energy lost due to mechanical friction, complexity of structure, maintenance and installation costs, etc. will become standards for selection.

FIG. 19 illustrates an elevator according to an eighth embodiment of the present invention. The elevator of this embodiment includes a balance maintenance means which is coupled to a driven shaft 226 that is coupled to a drive shaft 224 through an electronic control transmission 225. The balance maintenance means comprises a hydraulic motor 279 to which a rotating shaft 278 is rotatably coupled and a liquefied gas tank 272, a high-pressure liquid tank 275 and an atmospheric pressure liquid lank 281, which are provided around the hydraulic motor 279. Liquefied gas is stored in the liquefied gas tank 27 to a predetermined level 271. The liquefied gas tank 27 is connected to the high-pressure liquid tank 275 through a pipe 273. Liquid is contained in the high-pressure liquid tank 275 to a predetermined level 276. Liquefied gas is contained with the liquid in the high-pressure liquid tank 275 to a predetermined level 274, such that they form a layer structure.

The high-pressure liquid tank 275 is connected to a side of the hydraulic motor 279 through a pipe 277. The hydraulic motor 279 is connected at an opposite side thereof to the atmospheric pressure liquid tank 281 through a pipe 280. Liquid is contained in the atmospheric pressure liquid tank 281 to a predetermined level 282.

* In the system having the above-mentioned construction, a high pressure of liquid in the high-pressure liquid tank 275 is constantly maintained by a vapor pressure in the liquefied gas tank 272.

A large liquid tank, which is placed in a building, in particular, at the top of the building, may cause a problem from a safety aspect of the building; also, some buildings may have no space at the top thereof. Furthermore, it is complex to install a liquid pipe from the top to the bottom of a building. If a device serving as an upper liquid tank can be placed at a lower position, for example, the bottom of the building and at a position adjacent to a lower liquid tank, there are a variety of advantages. As an example, the capacity of the liquid tank can be increased without limit.

Ammonia, a mixture of ammonia and vapor, carbon dioxide, sulfur dioxide, chlorine, and propane, can all be liquefied at room temperature, and all have different critical pressures. One kind of gas selected from the group consisting of the above-mentioned gases is contained in the liquefied liquid tank 272. Thereafter, the liquefied liquid tank 272 is coupled to the upper end of the high-pressure liquid tank 275 through the pipe 273, such that they communicate with each other. Then, the vapor pressure of the gas is applied to the high-pressure liquid tank 275, so that the pressure in the high-pressure liquid tank 275 is constantly maintained regardless of the amount of liquid contained in the tank. That is, if an amount of liquid in the high-pressure liquid tank 275 is reduced, because an upper space which is charged with gas is increased, the pressure in the tank is reduced. However, when the pressure in the high-pressure liquid tank is reduced, the liquefied gas is vaporized, thereby the pressure in the high-pressure liquid lank is constantly maintained. Conversely, if an amount of liquid in the high-pressure liquid tank is increased, because the upper space which is charged with gas is reduced, the pressure in the high-pressure liquid tank is increased, but, when the pressure in the high-pressure liquid tank is increased, because gas is simultaneously liquefied, the pressure in the high-pressure liquid tank is constantly maintained. The liquid in high-pressure liquid tank applies constant pressure to the hydraulic motor 279 coupled to the high-pressure liquid tank through the pipe 277. The liquid, which has passed through the hydraulic motor 279, enters the atmospheric pressure liquid tank 281 through the pipe 280 which is coupled to the bottom of the atmospheric pressure liquid tank 281. The gas must not dissolve easily in the liquid. Furthermore, the gas having the highest critical pressure is advantageous for the maintenance of high pressure in the high-pressure liquid tank. In the case that selected gas does dissolve easily in the liquid, a film, such as a vinyl film 284 which does not allow gas or liquid to pass through it, may be provided in the high-pressure liquid tank 275, such that the gas is separated from the liquid. It is preferable that the vinyl film 284 have a size such that the high-pressure liquid tank 275 is fully charged with liquid, and a little liquid be applied to the upper surface of the vinyl film 284 such that the vinyl film 284 easily slides on the inner surface of the high-pressure liquid tank 275 without being stuck to the inner surface of the tank. Here, because a pressure in a space above the vinyl film 284 is always equal to that of a space beneath the vinyl film 284, there is no chance that the vinyl film 284 tears due to a pressure difference. In such a system, the liquefied gas tank 272 and the high-pressure liquid tank 275, which are disposed at a lower position, can substitute for an upper liquid tank 210 disposed at a high position and shown in each of FIGS. 14 and 15. The critical temperatures and the critical pressures of several materials are as follows. Those of ammonia are 132° C. and 111.2 atmospheres of pressure. Those of carbon dioxide are 31° C. and 72.8 atmospheres of pressure. Those of sulfur dioxide are 157.2° C. and 77.7 atmospheres of pressure. Those of chlorine are 144° C. and 76 atmospheres of pressure. In the case of each of the above-mentioned materials, when a pressure above the critical pressure is applied to the material at a room temperature, the material is liquefied and maintains a high vapor pressure.

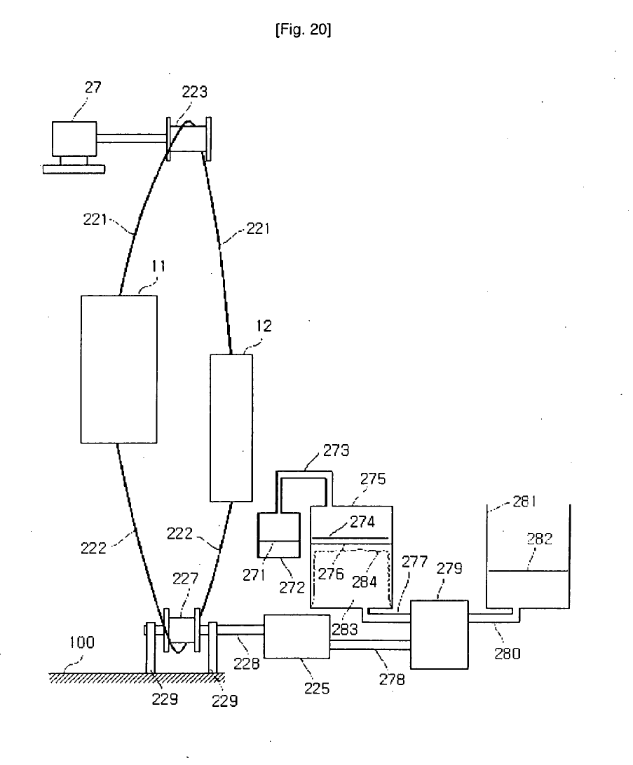

FIG. 20 is a schematic view showing an elevator according to a ninth embodiment of the present invention. Referring to FIG. 20, in this embodiment, a balance pulley shaft 298 is coupled to a balance pulley 227, and an electronic control transmission 225 is provided on the balance pulley shaft 228. Furthermore, a hydraulic motor 279 of a balance maintenance means, having the same construction as that shown in FIG. 19, is coupled to a shaft 278 of the electronic control transmission 225, thus accomplishing the same operational effect as that of the embodiment of FIG. 19. In the ninth embodiment, an installation of a liquid pipe from the top of a building to the bottom is not required and, as well, the rotating shaft 278, which is provided between the hydraulic motor 279 and the top in the embodiment of FIG. 19, is not required. Therefore, in the case of the ninth embodiment, there are advantages in that the number of elements of the elevator is reduced, and the structure thereof is simplified.

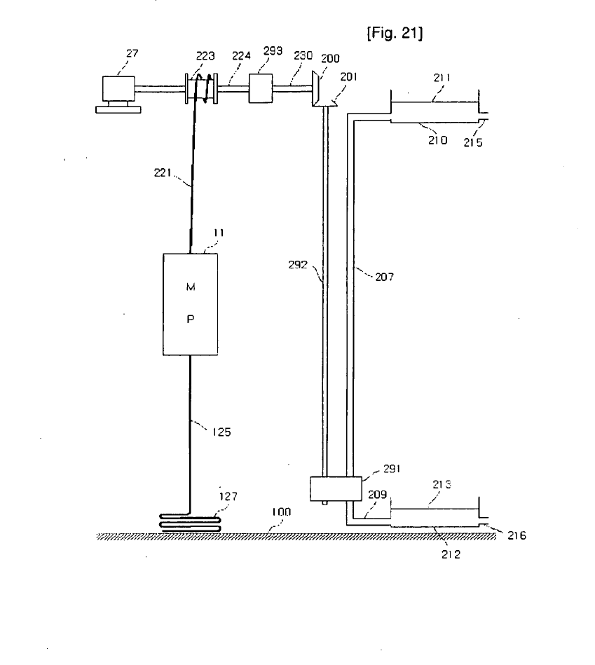

FIG. 21 is a schematic view showing an elevator according to a tenth embodiment of the present invention. This embodiment is a modification of the elevator of FIG. 14, in which an electronic variable capacity hydraulic motor 291 substitutes both for the transmission including the gears 7 and 8 of FIG. 14, and for the hydraulic motors 203, 204, 205 and 206 of FIG. 14.

Furthermore, an electronic control brake 293, which is controlled by a control unit that is not shown in the drawing, is provided on a shaft 224 of a winch 223, thus executing the same function as that of the brake 71 of the electronic control transmission 21, 225 described in FIG. 4, thereby the shaft 224 is controlled. In the case of the electronic variable capacity hydraulic motor 291, a torque and rotating speed of the output shaft of the motor relative to the pressure and speed of liquid drawn into the motor are controlled by adjusting displacement volume per one revolution of the motor. Furthermore, the electronic variable capacity hydraulic motor 291 may be regarded as having the same construction as that of a typical variable capacity hydraulic motor connected to a control unit.

In this embodiment, constant pressure is applied from an upper liquid tank 210 to the electronic variable capacity hydraulic motor 291 through a pipe 107. A liquid discharge rate of the electronic variable capacity hydraulic motor 291 is varied depending both on a rotating speed of a rotating shaft 292 of the electronic variable capacity hydraulic motor and on displacement volume per one revolution. The control unit controls the displacement volume per one revolution of the rotating shaft 292 of the electronic variable capacity hydraulic motor 291, thus adjusting the torque of the rotating shaft 292. Here, the torque of the rotating shaft 292 of the electronic variable capacity hydraulic motor 291 is adjusted to an appropriate degree to offset the torque of the shaft 230 of the brake 293, which is generated both by the weight of the cage 11 and by the weight of passengers and cargo in the cage. Furthermore, the rotating speed of the rotating shaft 292 of the electronic variable capacity hydraulic motor 291, which is coupled to the shaft 230 through bevel gears 200 and 201, is determined according to a rotating speed of the shaft 230 of the brake 293, which is rotated by rotation of an electromotor 27. The flow speed of liquid, which passes through the electronic variable capacity hydraulic motor 291 and flows through the pipe 207, is determined by the displacement volume per one revolution of the rotating shaft 292 of the electronic variable capacity hydraulic motor. For example, when the displacement volume per one revolution of the rotating shaft 292 of the electronic variable capacity hydraulic motor is adjusted to be zero, the liquid which has passed through the pipe 207 is stopped, and the rotating shaft 292 of the electronic variable capacity hydraulic motor enters a state of no-load operation. This state is the same as when the brake 73 of the electronic control transmission 21, 225 of FIG. 14 is operated while the electronic control transmission is in a neutral state. Judged from this, it can be appreciated that, in the case of use of the electronic variable capacity hydraulic motor 291, the separate brake 73, which is provided on the driven shaft of the electronic control transmission 21, 225 shown in FIG. 14, is not required.

The electronic variable capacity hydraulic motor is classified into a vane type and a piston type. Such an electronic variable capacity hydraulic motor also serves as a hydraulic pump. That is, when the cage 11 is moved upwards by rotation of the electromotor 27, the electronic variable capacity hydraulic motor serves as a hydraulic motor. For this, liquid flows from the upper liquid tank 210 to the lower liquid tank 212, so that torque is generated, thereby power of the electromotor for raising the cage 11 is saved. Conversely, when the cage 11 is moved downwards, the electronic variable capacity hydraulic motor 291 serves as a hydraulic pump. Thus, the hydraulic motor 291 pumps liquid from the lower liquid tank 212 to the upper liquid tank 210, thereby compensating for potential energy lost by the downward movement of the cage 11.

As such, it can be appreciated that the single electronic variable capacity hydraulic motor 291 can substitute both for the transmission including the gears 7 and 8 and for the hydraulic motors 203, 204, 205 and 206.

Meanwhile, in FIG. 21, the same components as those described in the former drawings are designated by the same reference numerals, and further explanation about this has been omitted.

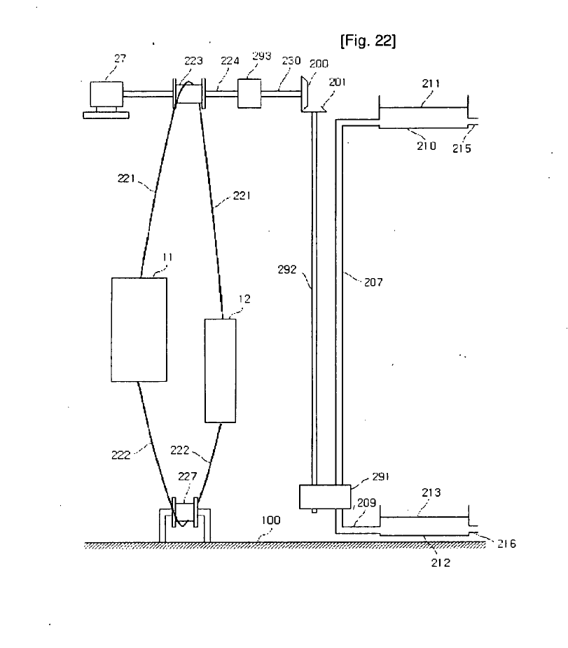

FIG. 22 is a schematic view showing an elevator according to an eleventh embodiment of the present invention. FIG. 22 shows a modification of the elevator of FIG. 15, in which a single electronic variable capacity hydraulic motor 291 substitutes both for gear-shifting-related parts of the transmission 225 of FIG. 15 and for the hydraulic motors 203, 204, 205 and 206. The operation of the electronic variable capacity hydraulic motor 291 of this embodiment is the same as that described in FIG. 21, therefore further explanation is deemed unnecessary. Furthermore, other components are the same as those described in FIG. 15, therefore further explanation will be omitted.

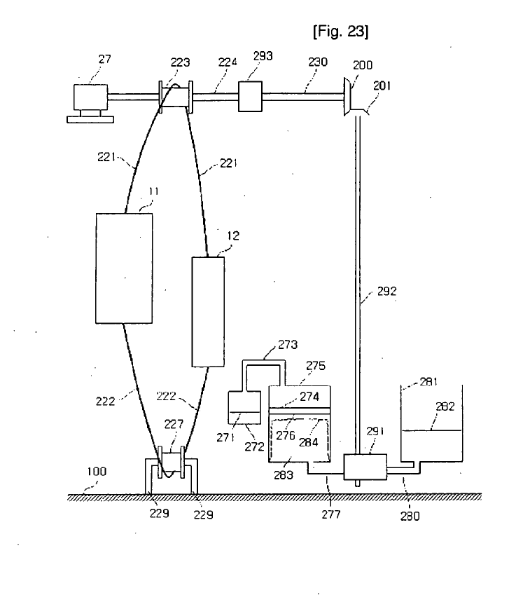

FIG. 23 is a schematic view showing an elevator according to a twelfth embodiment of the present invention. FIG. 23 shows a modification of the elevator of FIG. 19 in which a single electronic variable capacity hydraulic motor 291 substitutes both for transmission gears (not shown) of the transmission 225 of FIG. 19, other than the brake 293, and for the hydraulic motor 279. In FIG. 23, the same components as those of FIG. 19 are designated by the same reference numerals. Furthermore, the principle of how the single electronic variable capacity hydraulic motor 291 serves as both the transmission and hydraulic motor has already been described in the explanation for FIG. 21, therefore further explanation is deemed unnecessary.

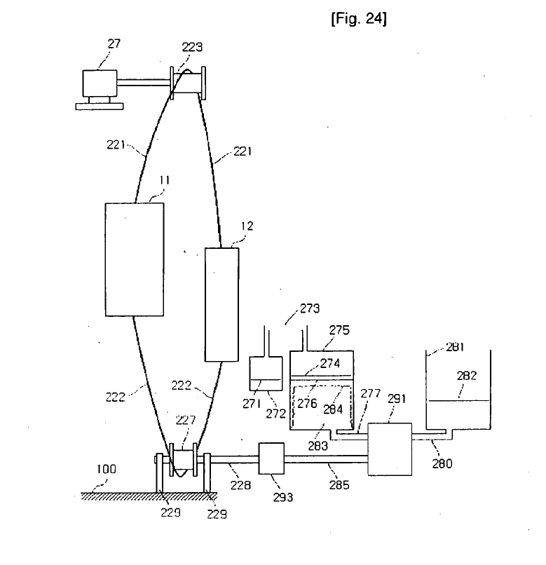

FIG. 24 is a schematic view showing an elevator according to a thirteenth embodiment of the present invention. FIG. 24 shows a modification of the elevator of FIG. 20 in which a single electronic variable capacity hydraulic motor 291 substitutes both for gear-shifting-related parts of the transmission 225 of FIG. 20, that is, transmission gears, other than the brake 293, and for the hydraulic motor 279. Even in FIG. 24, the same components as those of FIG. 20 are designated by the same reference numerals. Furthermore, the principle of how the single electronic variable capacity hydraulic motor 291 serves as both the transmission and hydraulic motor will be easily appreciated through the explanation of FIG. 21, therefore further explanation is deemed unnecessary.

Although the preferred embodiments of the present invention have been disclosed for illustrative purposes, the present invention is not limited to the preferred embodiments. Furthermore, those skilled in the art will appreciate that various modifications, additions and substitutions are possible, without departing from the scope and spirit of the invention as disclosed in the accompanying claims.

### INDUSTRIAL APPLICABILITY

As described above, in an elevator of the present invention, a gear ratio of a transmission is adjusted in consideration of the number of passengers or the weight of cargo, so that there is an advantage in that power consumption required for operating the elevator is reduced.

Furthermore, in the case of the use of an electronic variable capacity hydraulic motor, the present invention is controlled depending on the change in weight of passengers and cargo, such that a balance weight offsets the weight of a cage, the passengers and the cargo to the utmost, thus reducing power consumption required for operating the elevator.

1-37. (canceled)

38. An elevator for carrying passengers and cargo, the elevator comprising:
an electromotor;
a cage for carrying the passengers and cargo;
a cage winch rotated by the electromotor, so that a wire rope coupled to the cage is wound around or unwound from the cage winch;
a balance weight providing a predetermined load to balance a weight of the cage and a weight of the passengers and cargo to be carried by the cage;
a balance weight winch rotated using power transmitted from the cage winch to raise the balance weight;
gear ratio changing means provided between the balance weight winch and the cage winch to selectively transmit power therebetween, the electronic control transmission being set into a predetermined gear ratio according to an input signal and transmitting power between the winches; and
a control unit to control the gear ratio changing means in consideration of the weight of the cage, the passengers and the cargo, a weight of the balance weight, and positions of the cage and balance weight, so that the gear ratio changing means is set into a gear ratio such that the weight of the cage side is balanced with the weight of the balance weight,
wherein the cage winch is provided on a driving shaft which is coupled between the electronic control transmission and the electromotor, and the balance weight winch is provided on a following shaft, which is coupled to the electronic control transmission so that power is transmitted from the driving shaft to the following shaft.

39. The elevator according to claim 38, wherein the gear ratio changing means is an electronic control transmission.

40. The elevator according to claims 39, wherein the electronic control transmission is a continuously variable transmission.

41. The elevator according to claims 39, wherein the electronic control transmission accomplishes its transmission function according to the control unit, and further comprises an electronic control brake on the driving shaft and following shaft thereof respectively.

42. An elevator for carrying passengers and cargo, the elevator comprising:
an electromotor;
a cage for carrying the passengers and cargo;
a cage winch rotated by the electromotor, so that a wire rope coupled to the cage is wound around or unwound from the first winch;
balance maintenance means for providing a predetermined load to balance a weight of the cage and a weight of the passengers and cargo to be carried by the cage;
power transmission means provided between a shaft of the cage winch and a shaft of the balance maintenance means to selectively transmit power therebetween, the power transmission means being set into a predetermined gear ratio according to an input signal and transmitting power from the cage winch to the balance maintenance means; and
a control unit to control the electronic control transmission in consideration of the weight of the cage, the weight of the passengers and cargo, the load of the balance maintenance means, and a position of the cage, so that the electronic control transmission is set into a gear ratio such that the weight of the cage side is balanced with the load of the balance maintenance means, wherein the balance maintenance means comprises: high-pressure liquid storing means for storing high-pressure liquid;
an atmospheric pressure liquid storing means for storing atmospheric pressure liquid, the means being connected to the high-pressure liquid storing means through a pipe; and
a hydraulic motor for carrying liquid either the high-pressure liquid storing means or the atmospheric pressure liquid storing means depending on the rotation direction of the hydraulic motor, the motor being provided on the pipe between the high-pressure liquid storing means and the atmospheric pressure liquid storing means, wherein the shaft of the balance maintenance means is a shaft of the hydraulic motor.

43. The elevator according to claim 42, wherein the power transmission means is an electronic control brake provided with a brake on the rotating shaft thereof, and the hydraulic motor is an electronic variable capacity hydraulic motor which adjusts its capacity according to the input signal of the control unit.

44. The elevator according to claim 42, wherein the power transmission means is gear ratio changing means.

45. The elevator according to claim 44, wherein the gear ratio changing means is an electronic control transmission.

46. The elevator according to claim 45, wherein the electronic control transmission is a continuously variable transmission.

47. The elevator according to claim 45, wherein the electronic control transmission accomplishes its transmission function according to the control unit, and further comprises an electronic control brake on the driving shaft and following shaft thereof, respectively.

48. The elevator according to claim 42, wherein the high-pressure liquid storing means includes an airtight liquefied gas tank for storing liquefied gas; and an airtight high-pressure liquid tank being connected to the airtight liquefied gas tank and the atmospheric pressure liquid storing means, respectively, through pipes, the airtight high-pressure liquid tank storing the liquefied gas enabling to move into the airtight liquefied gas tank and storing liquid enabling to move to the atmospheric pressure liquid storing means, the liquefied gas and the liquid being divided, and the atmospheric pressure liquid storing means includes an atmospheric pressure liquid tank for storing atmospheric pressure liquid.

49. The elevator according to claim 42, wherein the high-pressure liquid storing means includes an upper liquid tank for storing liquid, and the atmospheric pressure liquid storing means includes an lower liquid tank for storing liquid.

50. The elevator according to claim 42, wherein the hydraulic motor includes a plurality of hydraulic motors, and the plurality of hydraulic motors are connected to each other by at least one method of serial and parallel connection methods.

51. An elevator for carrying passengers and cargo, the elevator comprising:
an electromotor;
a cage for carrying the passengers and cargo;
a closed-loop-type wire rope for coupling the cage;
a cage winch rotated by the electromotor and moving the wire rope;
a balance pulley provided at a position corresponding to the cage winch to support the movement of the wire rope;
balance maintenance means for providing a predetermined load to balance against a weight of the cage and a weight of the passengers and cargo to be carried by the cage;
power transmission means for selectively transmitting power, the means being connected to a shaft of the balance maintenance means and selected with a predetermined gear ratio according to an input signal;
a control unit for controlling the power transmission means to select the gear ratio in which the weight of the cage is balanced with the load of the balance maintenance means, in consideration of the weight of the cage, the passengers and the cargo, the load of the balance maintenance means and the position of the cage, wherein the balance maintenance means comprises:
high-pressure liquid storing means for storing high-pressure liquid;
an atmospheric pressure liquid storing means for storing atmospheric pressure liquid, the means being connected to the high-pressure liquid storing means through a pipe; and
a hydraulic motor for carrying liquid either the high-pressure liquid storing means or the atmospheric pressure liquid storing means depending on the rotation direction of the hydraulic motor, the motor being provided on the pipe between the high-pressure liquid storing means and the atmospheric pressure liquid storing means, wherein the shaft of the balance maintenance means is a shaft of the hydraulic motor.

52. The elevator according to claim 51, further comprising a balance weight for balancing with the closed-loop-type wire rope, the balance weight having a predetermined weight corresponding with the cage and connected with the closed-loop-type wire rope.

53. The elevator according to claim 51, wherein the power transmission means is connected with the shaft of the balance pulley and transmits the power of the balance pulley to the balance maintenance means.

54. The elevator according to claim 51, wherein the power transmission means is connected with the shaft of the cage winch and transmits the power of the cage winch to the balance maintenance means.

55. The elevator according to claim 51, wherein the power transmission means is an electronic control brake provided with a brake on the rotating shaft thereof, and the hydraulic motor is an electronic variable capacity hydraulic motor which adjusts its capacity according to the input signal of the control unit.

56. The elevator according to claim 51, wherein the power transmission means is gear ratio changing means.

57. The elevator according to claim 56, wherein the gear ratio changing means is an electronic control transmission.

58. The elevator according to claim 57, wherein the electronic control transmission is a continuously variable transmission.

59. The elevator according to claim 57, wherein the electronic control transmission accomplishes its transmission function according to the control unit, and further comprises an electronic control brake on the driving shaft and following shaft thereof, respectively.

60. The elevator according to claim 51, wherein the high-pressure liquid storing means includes an airtight liquefied gas tank for storing liquefied gas; and
an airtight high-pressure liquid tank being connected to the airtight liquefied gas tank and the atmospheric pressure liquid storing means, respectively, through pipes, the airtight high-pressure liquid tank storing the liquefied gas enabling to move into the airtight liquefied gas tank and storing liquid enabling to move to the atmospheric pressure liquid storing means, the liquefied gas and the liquid being divided, and the atmospheric pressure liquid storing means includes an atmospheric pressure liquid tank for storing atmospheric pressure liquid.

61. The elevator according to claim 51, wherein the high-pressure liquid storing means includes an upper liquid tank for storing liquid, and the atmospheric pressure liquid storing means includes an lower liquid tank for storing liquid.

62. The elevator according to claim 51, wherein the hydraulic motor includes a plurality of hydraulic motors, and the plurality of hydraulic motors are connected to each other by at least one method of serial and parallel connection methods.
